(19) United States
(12) Patent Application Publication
(10) Pub. No.: US 2023/0314582 A1
(43) Pub. Date: Oct. 5, 2023

(54) ULTRASONIC BEAMFORMING SYSTEM AND METHOD

(71) Applicant: Electronic Technologies LLC dba Versa Electronics, New Hope, MN (US)

(72) Inventor: Jarrod Eliason, Brooklyn Park, MN (US)

(21) Appl. No.: 18/194,957

(22) Filed: Apr. 3, 2023

Related U.S. Application Data
(60) Provisional application No. 63/326,939, filed on Apr. 4, 2022.

(51) Int. Cl. G01S 7/521; G01S 15/89

(52) U.S. Cl. CPC G01S 7/521; G01S 15/89; G01S 15/96

(57) ABSTRACT

A three-dimensional ultrasonic mapping system may combine mechanical rotation with a multibeam ultrasonic transducer assembly using a combination of frequency and phase beamforming to steer linear arrays of transducer elements over a range of angles. An array may be divided into a number of channels that may be less than the number of transducer elements in the array. A phase difference between adjacent transducer elements may be an integer multiple of 360 degrees divided by the number of channels. The ultrasonic beamforming system of the transducer assembly may produce near real-time two-dimensional imaging. Mechanical rotation of the transducer assembly may enable three-dimensional ultrasonic mapping. In some implementations, an arrangement of multiple sets of two frequency and phase steered arrays may enable the three-dimensional ultrasonic mapping.

### CROSS REFERENCE TO RELATED APPLICATION(S)

This application claims priority to and the benefit of U.S. Provisional Patent Application Ser. No. 63/326,939, filed Apr. 4, 2022, the entire disclosure of which is hereby incorporated by reference.

### FIELD

The present teachings relate to an ultrasonic beamforming system and method, including a multibeam ultrasonic transducer assembly and a three-dimensional ultrasonic mapping system that maps a region of water.

### BACKGROUND

Sonar systems have been developed for use in detecting fish. Early systems detected fish and bottom echoes directly below a transducer so that a user can see the distance to fish directly below a transducer on a display with one spatial dimension that is updated after each transmit and receive cycle to produce a near real-time one-dimensional image. This one-dimensional sonar technology has been combined with translation or rotation of the transducer to build a two-dimensional image by combining data from multiple one-dimensional images collected when the transducer was at different positions or rotation angles. Side scan, sector scan and down scan sonars with chart displays are examples of such two-dimensional imaging sonars. More recently, some systems have implemented beamforming using linear arrays of transducer elements to steer a primary direction of ultrasonic energy propagation, known as a beam, by adjusting a time delay or phase delay between adjacent transducer elements in the linear array. Near real-time two-dimensional images can be produced by transmitting and receiving multiple beams during a single cycle of transmit and receive.

### SUMMARY

Disclosed herein are aspects, features, elements, implementations, and embodiments of ultrasonic beamforming.

An aspect of the disclosed embodiments is a system comprising transmit beamforming electronics configured to control a transducer assembly to transmit a plurality of beams around an electronic beam steering axis by varying a frequency and a phase between channels connected to transducer elements of the transducer assembly, wherein the channels are greater in number than two and less in number than the transducer elements, and a phase difference between adjacent channels is an integer multiple of 360 degrees divided by the number of channels; receive beamforming electronics configured to detect, via the transducer assembly, a plurality of echoes caused by the plurality of beams; a rotator configured to rotate the transducer assembly around a rotation axis that is perpendicular to the electronic beam steering axis while transmitting the plurality of beams and detecting the plurality of echoes; and a processor configured to execute instructions stored in a memory to generate a three-dimensional ultrasonic mapping based on the plurality of echoes and output the three-dimensional ultrasonic mapping to a display unit.

Another aspect of the disclosed embodiments is a method comprising controlling a transducer assembly to transmit a plurality of beams around an electronic beam steering axis by varying a frequency and a phase between channels connected to transducer elements of the transducer assembly, wherein the channels are greater in number than two and less in number than the transducer elements, and a phase difference between adjacent channels is an integer multiple of 360 degrees divided by the number of channels; detecting, via the transducer assembly, a plurality of echoes caused by the plurality of beams; rotating the transducer assembly around a rotation axis that is perpendicular to the electronic beam steering axis while transmitting the plurality of beams and detecting the plurality of echoes; and generating a three-dimensional ultrasonic mapping based on the plurality of echoes, the three-dimensional ultrasonic mapping being output to a display unit.

Another aspect of the disclosed embodiments is a system comprising a transducer assembly including multiple sets of two frequency and phase steered transducer arrays, each set of two frequency and phase steered transducer arrays angled relative to adjacent sets of two frequency and phase steered transducer arrays; transmit beamforming electronics configured to control the transducer assembly to transmit a plurality of beams around an electronic beam steering axis by varying a frequency and a phase between channels connected to transducer elements of the transducer array; receive beamforming electronics configured to detect, via the transducer assembly, a plurality of echoes caused by the plurality of beams; and a processor configured to execute instructions stored in a memory to generate a three-dimensional ultrasonic mapping based on the plurality of echoes and output the three-dimensional ultrasonic mapping to a display unit.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

FIG. 1A is a front exploded perspective view of a multibeam ultrasonic transducer assembly.

FIG. 1B is a back exploded perspective view of a multibeam ultrasonic transducer assembly.

FIG. 2A is a schematic drawing of beam angles covered by one frequency and phase steered transducer array.

FIG. 2B is a schematic drawing of two frequency and phase steered transducer arrays angled relative to each other.

FIG. 2C schematically shows a combined angle of coverage of the two frequency and phase steered transducer arrays of FIG. 2B.

FIG. 3A schematically shows an exemplary arrangement of ninety-six transducer elements forming a frequency and phase steered transducer array.

FIG. 3B is an enlarged view of a circled portion IIIB of FIG. 3A, showing eight adjacent elements assigned to eight separate electronic channels.

FIG. 4A schematically depicts a relative phase relationship between eight adjacent channels with 45 degree phase delay between the channels, according to FIG. 3A.

FIG. 4B schematically depicts a relative phase relationship between eight adjacent channels with 90 degree phase delay between the channels, according to FIG. 3A.

FIG. 4C schematically depicts a relative phase relationship between eight adjacent channels with 135 degree phase delay between the channels, according to FIG. 3A.

FIG. 4D schematically depicts a relative phase relationship between eight adjacent channels with −45 degree phase delay between the channels, according to FIG. 3A.

FIG. 4E schematically depicts a relative phase relationship between eight adjacent channels with −90 degree phase delay between the channels, according to FIG. 3A.

FIG. 4F schematically depicts a relative phase relationship between eight adjacent channels with −135 degree phase delay between the channels, according to FIG. 3A.

FIG. 5 schematically shows plots of beam steering of an exemplary array with eight channels, including steering angles at different frequencies and phases.

FIG. 6 is a perspective view of a multibeam ultrasonic transducer assembly containing two transducer arrays arranged to cover a continuous steering angle range of at least 160 degrees.

FIG. 7A is a table of parameters for an exemplary transducer array and example sound velocity in water.

FIG. 7B is a table of calculated frequencies and phases that provide beam steering from 15 degrees to 65 degrees and from −15 degrees to −65 degrees, based on the transducer array parameters of FIG. 7A.

FIG. 7C is an alternative table of frequencies and phases that provide beam steering angles from approximately 15 degrees to approximately 65 degrees and from approximately −15 degrees to approximately −65 degrees.

FIG. 7D is a table of unique frequencies for steering the 8-channel array of FIG. 5, including samples per cycle and samples per eight cycles.

FIG. 7E schematically shows a top-down view of beams formed using the transducer parameters of the table of FIG. 7A and the positive frequencies and phases of the table of FIG. 7C.

FIG. 7F is a graph that plots beam widths in the steering direction and beam widths perpendicular to the steering direction versus steering angle, for the beams of FIG. 7E.

FIG. 8A is a flow diagram depicting devices and one method of transmit beamforming using sequential delays.

FIG. 8B is a flow diagram depicting an example of transmit beamforming, involving wrapping all phase angles to a range between 0 and 360 degrees.

FIG. 9A is a flow diagram depicting digital signal processing and receive beamforming based upon digital In phase-Quadrature (I-Q) demodulation and beam normalization.

FIG. 9B is a schematic depiction of a finite impulse response (FIR) low-pass filter.

FIG. 9C is a schematic depiction of a down-sampling FIR low-pass filter.

FIG. 9D is a schematic depiction of a down-sampling averaging filter.

FIG. 10 is a block diagram of the multibeam ultrasonic transducer assembly of FIG. 6.

FIG. 11A is a schematic, cross-sectional view of part of a piezoelectric transducer, illustrating a single acoustic matching layer between a piezoelectric element and water.

FIG. 11B is a schematic, cross-sectional view of part of a piezoelectric transducer with a two-layer acoustic matching structure used in wide bandwidth systems.

FIG. 11C is a schematic, cross-sectional view of part of a piezoelectric transducer with a two-layer acoustic matching structure utilizing composite materials.

FIG. 11D is a schematic, cross-sectional view of part of a piezoelectric transducer with a gradient acoustic matching layer.

FIG. 11E is a schematic, cross-sectional view of part of a piezoelectric transducer with a metamaterial acoustic matching structure.

FIG. 11F is a schematic, cross-sectional view of part of a piezoelectric transducer with a metamaterial acoustic matching structure including discrete sub-layers with varying volume of material drilled out from one material and replaced by a second material.

FIG. 11G is a schematic, cross-sectional view of part of a piezoelectric transducer with a metamaterial acoustic matching structure including discrete sub-layers with filled holes having a common diameter.

FIG. 11H is a schematic, cross-sectional view of part of a piezoelectric transducer with a metamaterial acoustic matching structure including discrete sub-layers with aligned filled holes having common diameter.

FIG. 11I is a schematic, cross-sectional view of part of a piezoelectric transducer with a two-layer acoustic matching structure having a metamaterial matching layer and a gradient acoustic matching layer.

FIG. 12A is a schematic, isometric view of a three-dimensional ultrasonic mapping system for operation on a stationary platform and employing mechanical rotation of a transducer around a Z axis.

FIG. 12B is a schematic, isometric view of a three-dimensional ultrasonic mapping system for operation on a stationary platform and employing mechanical rotation of a transducer around an X axis.

FIG. 12C is a schematic, isometric rendering of a three-dimensional ultrasonic mapping system in use during ice-fishing.

FIG. 13 is a block diagram of a three-dimensional ultrasonic mapping system.

FIG. 14A depicts time sequence top-down view snapshots of a beam rotating past a large object.

FIG. 14B depicts time sequence top-down view snapshots of a beam rotating past a small object.

FIG. 14C is a graph plotting expected amplitude versus rotation angle for each of the objects of FIGS. 14A and 14B.

FIG. 15 demonstrates the relationship between water temperature, salinity and sound velocity.

FIG. 16A is an isometric view of a woven mesh material.

FIG. 16B is a top-down view of a woven mesh material.

FIG. 17 depicts a variety of meshes with varying wire size and mesh size.

FIG. 18 is an isometric view of a simplified beam set coverage area with 160 degree coverage around an electronic beam steering axis and 20 degree beam width perpendicular to the electronic beam steering axis.

FIG. 19 depicts two beam set coverage areas as in FIG. 18 where the two beam sets are rotated 5 degrees around a vertical rotation axis relative to each other.

FIGS. 20A through 20D provide four different views of 36 beam set coverage areas as in FIG. 18 where each beam set is rotated 5 degrees around a vertical axis relative to each other and a combined beam set coverage of 360 degrees around the vertical axis is achieved by rotation through 180 degrees.

FIG. 21 depicts two beam set coverage areas as in FIG. 18 where the two beam sets are rotated 5 degrees around a horizontal rotation axis relative to each other.

FIGS. 22A through 22D provide four different views of 31 beam set coverage areas as in FIG. 18 where each beam set is rotated 5 degrees around a horizontal axis relative to each other and a combined beam set coverage of 360 degrees around a vertical axis is achieved by rotation through less than 160 degrees around the horizontal axis.

FIG. 23 demonstrates an arrangement of 9 sets of two frequency and phase steered transducer arrays configured to provide beam set coverage over an angle of at least 160 degrees in all directions without mechanical rotation.

FIG. 24 is a block diagram of an example internal configuration of a computing device of an ultrasonic beamforming system.

### DETAILED DESCRIPTION

With beamforming, transducer elements may be controlled independently to accomplish beam steering. This independent control results in the need for multiple sets of electronics, which increases system cost. Attempts have been made to steer a beam using frequency steering, which utilizes a fixed phase relationship between adjacent elements and varies the frequency to steer the beams. Frequency steered systems often use an element spacing that is greater than one-half the wavelength such that grating lobes are produced at an angle depending on the frequency. Systems that use frequency steering of grating lobes wire the elements such that the primary lobe is nulled and only two hardware channels are sampled. This reduction in the number of hardware channels provides significant cost savings over other beamforming systems, which may involve each element assigned to a separate channel.

Due to lower cost, frequency steered transducer arrays have increased in use for recreational sonars capable of near real-time two-dimensional imaging. However, frequency steered arrays have a relatively narrow range of angles which is achievable within the operating frequency range of practical devices. This narrow range of angles results in the need for a group of 3 frequency steered arrays aimed in different directions to be used to provide continuous coverage over a range of angles.

Frequency steered devices may be limited by the bandwidth of the transducer elements. For example, modern composite transducers may utilize dice-and-fill techniques, which have increased the bandwidth of ultrasonic transducer arrays. However, such wide bandwidth transducers may be expensive to produce and therefore not suitable for consumer sonars. Some manufacturers have introduced imaging sonars that operate over a frequency range approaching 75% bandwidth (e.g., 500 kHz-1,100 kHz). Even with this wide range of frequencies, the achievable steering angles are limited to a narrow range.

Some sonar systems may be capable of performing three-dimensional mapping by towing transducer arrays through the water. However, for ice-fishing and jigging from a stationary platform, towing transducer arrays is not practical. Some sonar systems have followed the example of radar and incorporated 360 degree rotation, either continuous or oscillatory, to provide three-dimensional mapping for stationary or slow-moving platforms. Continuous transducer rotation may involve a slip ring to maintain electrical connection throughout rotation. However, mechanical slip rings using brushes can be unreliable and noisy, and liquid mercury slip rings can be expensive for consumer products and present environmental and health risks.

Thus, there is a need for a sonar system that can improve steering of ultrasonic beams. There is also a need for a sonar system in which a large range of steering angles may be available. Further, it would be desirable to have a sonar system that provides a 360 degree view from a stationary platform without the need for a slip ring. Additionally, it would be desirable to have a sonar system that improves three-dimensional ultrasonic mapping for a user.

Implementations of this disclosure address problems such as these by an ultrasonic beamforming system, a multibeam ultrasonic transducer assembly, and/or a three-dimensional ultrasonic mapping system that can map a region of water beneath and surrounding the ultrasonic transducer assembly to detect underwater sea life. In some implementations, the present teachings provide a system that reduces the number of arrays in a system such as a frequency steered ultrasonic transducer array taught herein. In some implementations, the present teachings provide a system that increases the size of the steering angle ranges and reduces the gap between steering angle ranges. In some implementations, the present teachings provide a system that improves three-dimensional ultrasonic mapping. One or more of the foregoing systems may be accomplished by varying frequency and phase to steer beams emitted from a transducer assembly and/or by rotating the transducer assembly to generate a three-dimensional ultrasonic mapping.

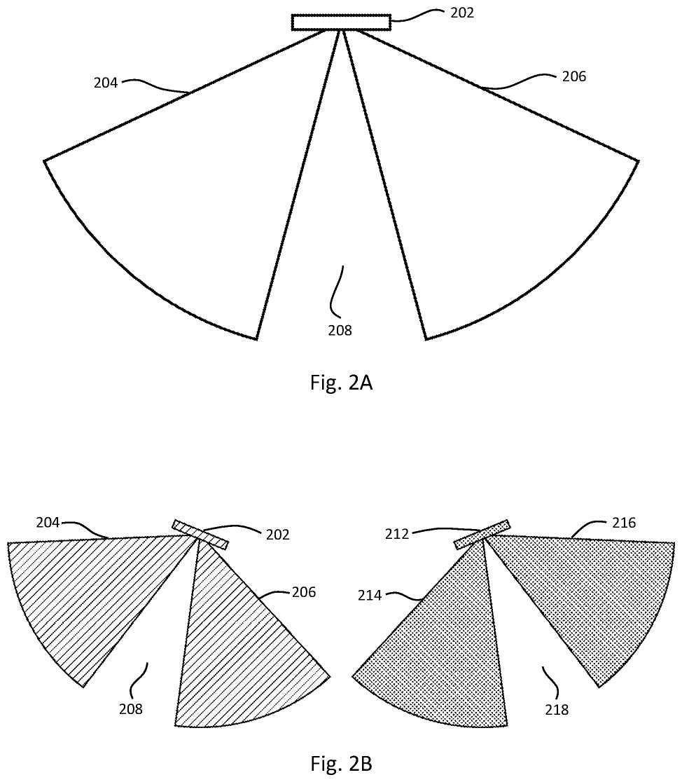

To describe some implementations in greater detail, reference is next made to examples of hardware and software structures used to implement an ultrasonic beamforming system, a multibeam ultrasonic transducer assembly, and/or a three-dimensional ultrasonic mapping system. FIG. 2A illustrates a representative frequency and phase steered transducer array 202, where each steering angle range 204 and 206 is larger than a gap 208 between the steering angle ranges 204, 206. The gap 208 can be considered to be an unused steering angle range of the transducer array 202. FIG. 2B shows two frequency and phase steered transducer arrays 202 and 212 angled relative to each other such that a steering angle range 214 of the array 212 fully overlaps the gap 208 of the array 202. In the same way, the steering angle range 206 of the array 202 fully overlaps a gap 218 of the array 212. FIG. 2C shows all four steering angle ranges 204, 206, 214, 216 of the two arrays 202, 212 together. In this transducer assembly, overlap is provided at each intersection to ensure continuous coverage. Additional overlap can be provided between the steering angle range 206 of the array 202 and the steering angle range 214 of the array 212, to provide reduced latency and/or angle of arrival estimation for objects that might exist in the overlapping region. This region directly below the transducer assembly is of greatest interest for vertical jigging fishing situations such as ice-fishing or jigging from a stationary boat.

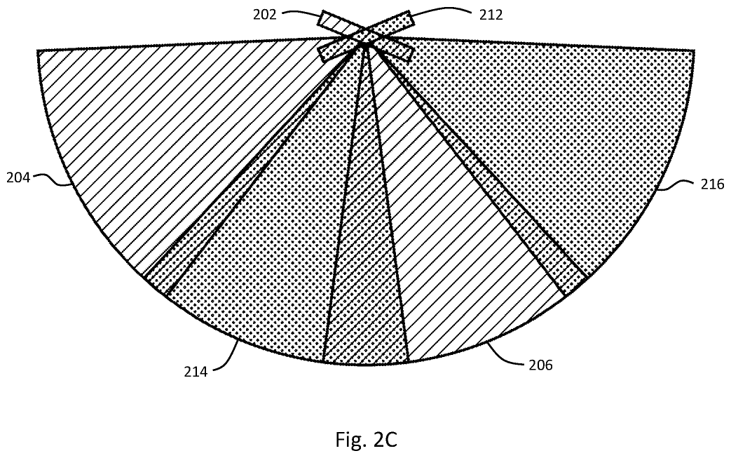

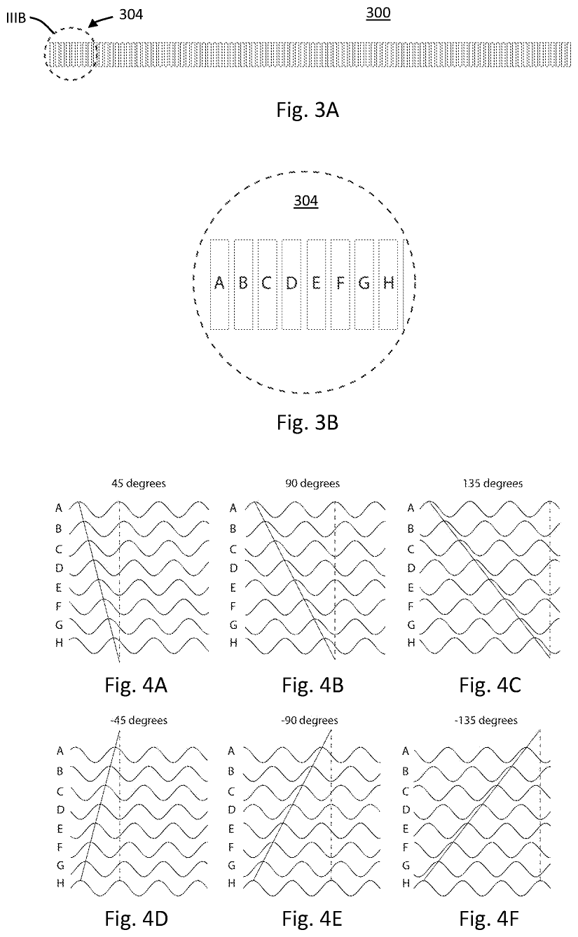

FIG. 3A shows an exemplary 96-element frequency and phase steered array 300, which can achieve the steering angle ranges shown in FIG. 2A. A group of 8 elements 304 of the array 300 is also shown in the enlarged view of FIG. 3B. Each element in the group of 8 elements 304 is assigned to a different electronic channel of a set of electronic channels A-H. Each group of 8 elements receives the same channel assignments. In this way, the first element of the array 300 is electrically connected to the ninth element of the array 300, the second element of the array 300 is electrically connected to the tenth element of the array 300, and so on. The present teachings provide 8 channels; however, other numbers of channels can be used without changing the nature of the present invention (e.g., as few as 3 channels, or as many as 32 channels or more, may be used with varying trade-offs between electronics cost and steering angle range).

FIGS. 4A-4F depict six inter-element phases that can be used in combination with frequency to steer the beams produced by the array 300. Additional phases can be used but are not shown. The teachings herein provide that no phase discontinuities exist between the groups (e.g., the group of 8 elements 304). This is achieved by limiting the phases to be an integer multiple of 360 degrees divided by the number of channels. For this 8-channel example, the allowable phases are integer multiples of 45 degrees. FIG. 4A demonstrates a 45 degree phase delay between adjacent channels, such that channel A in each group is in phase with and can be electrically connected to channel A in every other group. FIG. 4B similarly demonstrates a 90 degree phase delay, and FIG. 4C similarly demonstrates a 135 degree phase delay.

FIG. 4D demonstrates a −45 degree phase delay. In contrast to FIG. 4A, which depicts that channel A leads the other channels, in FIG. 4D, channel H leads the other channels. This relationship applies to transmit beamforming circuitry, as described below. FIG. 4E and FIG. 4F respectively demonstrate −90 degree and −135 degree phase delays.

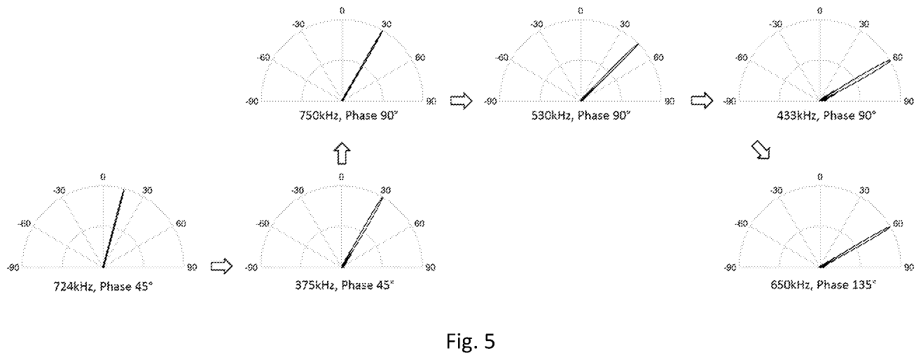

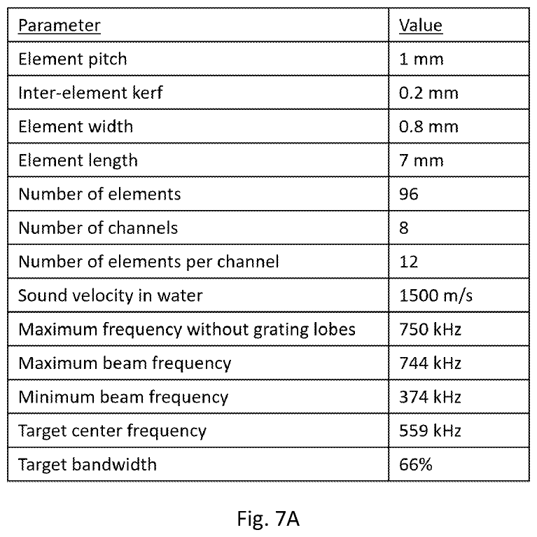

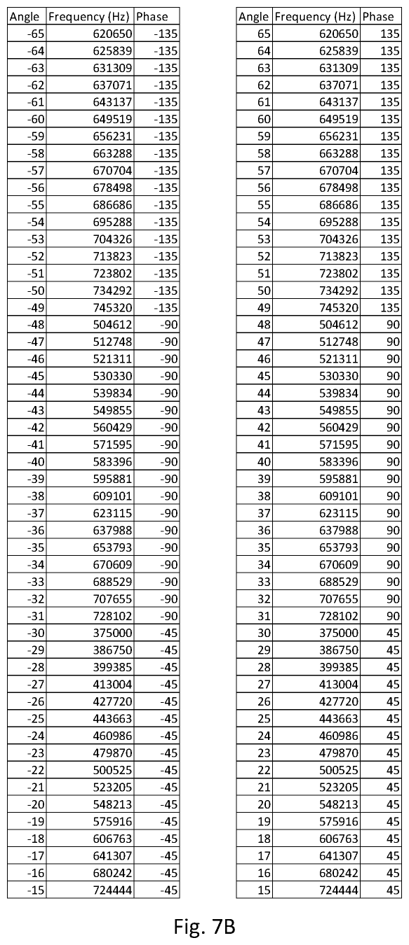

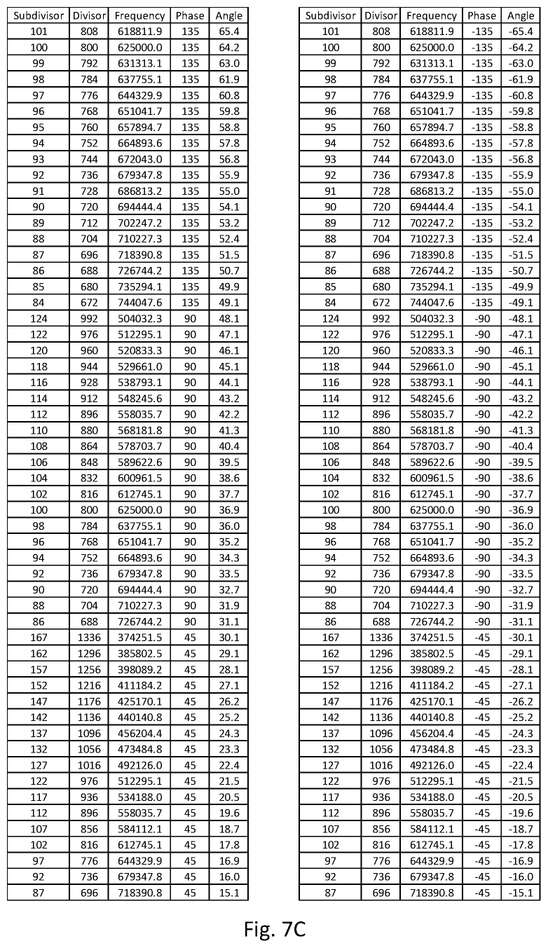

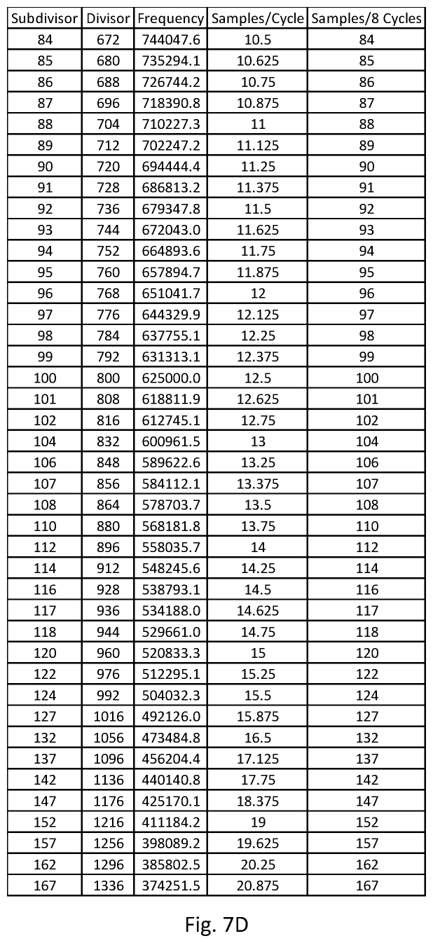

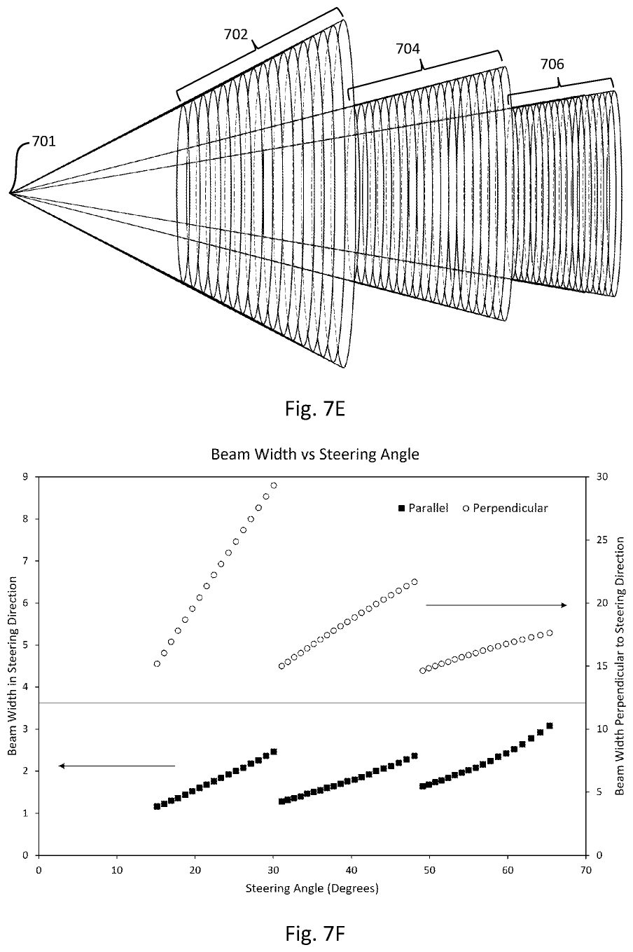

The steering angles at different frequencies and phases for an 8-channel array with parameters summarized in FIG. 7A are plotted in FIG. 5. Starting at 724 kHz with a phase of 45 degrees, the steering angle is approximately 15 degrees from broadside. As the frequency is reduced to 375 kHz, the steering angle is increased to 30 degrees. A steering angle of 30 degrees can also be achieved by doubling the frequency to 750 kHz and doubling the phase to 90 degrees. From here, lowering the frequency to 530 kHz increases the steering angle to 45 degrees. The frequency can be lowered further to 433 kHz to achieve a steering angle of 60 degrees. However, at this combination of frequency and phase, the beam width is increasing, which reduces the angular resolution of the system. To maintain a narrower beam width, the system is shifted to a phase of 135 degrees and a frequency of 650 kHz to achieve a steering angle of 60 degrees. Beam steering may extend beyond 60 degrees. In this approach, phase is used in a manner that is analogous to an automobile transmission mechanism, providing different “gears” in which the frequency steering can operate.

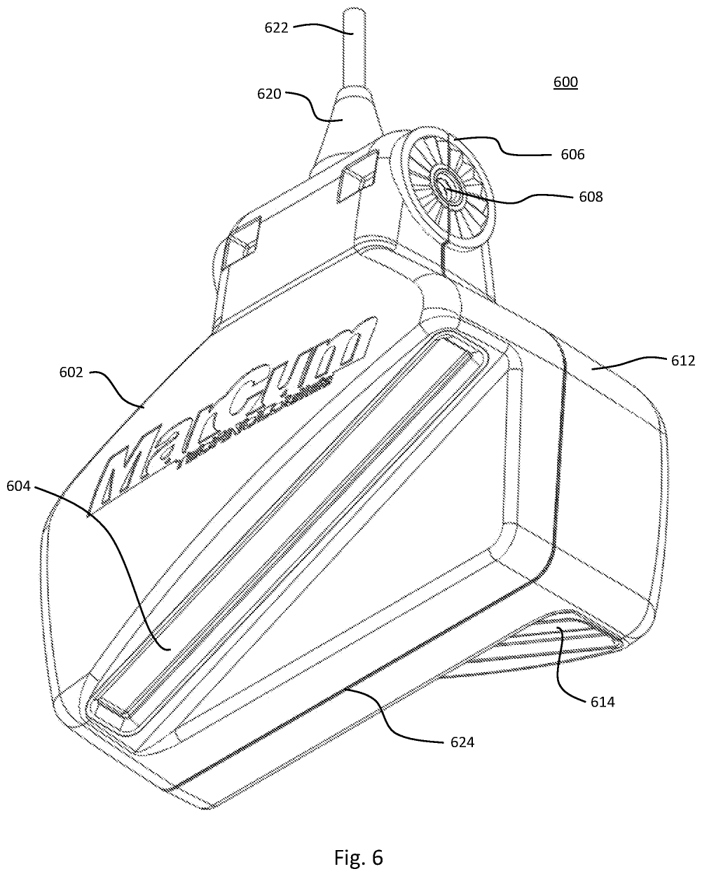

FIG. 6 is a perspective view of a multibeam ultrasonic transducer assembly 600 employing two arrays 604, 614 to achieve continuous coverage over a steering angle range of 160 degrees or greater. The multibeam ultrasonic transducer assembly 600 may also be referred to as a multibeam sonar transducer assembly 600, or simply a transducer assembly 600, or a multibeam two-dimensional ultrasonic imaging sonar. The arrays 604, 614 are enclosed in a housing having a front half 602 and a back half 612 which meet at a parting line 624. For manufacturing purposes, the housing could alternatively be divided into a top half and a bottom half. The transducer assembly 600 is connected to an external display unit (not shown) through a cable 622, which can include a strain relief 620. The transducer assembly 600 can be suspended from the cable 622 or mounted to a bracket using a molded multi-angle mounting feature 606 and threaded insert 608 to receive a mounting bolt (not shown).

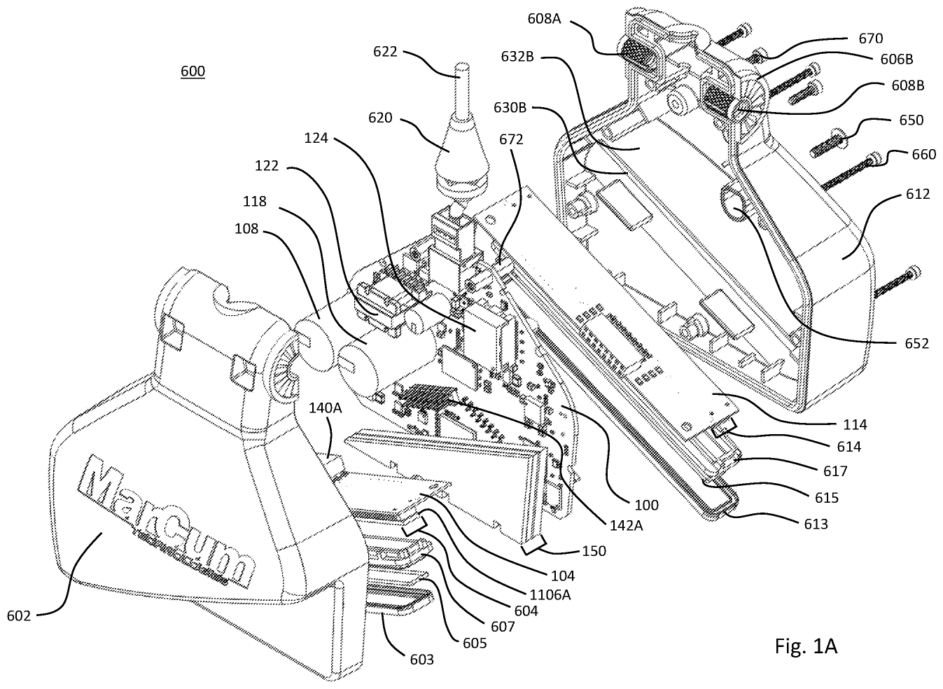

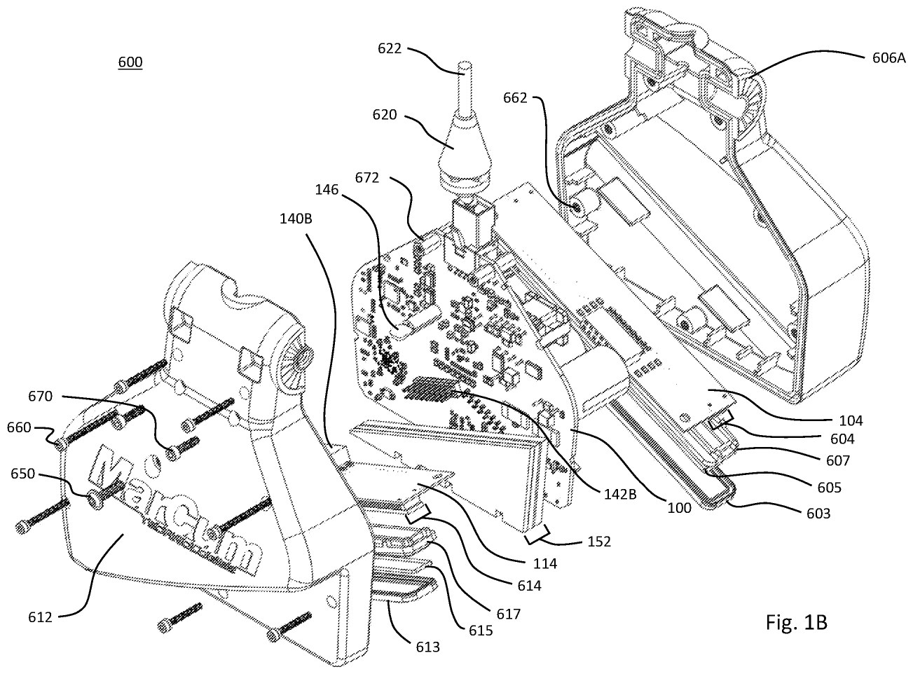

FIGS. 1A and 1B are front and back exploded perspective views of the multibeam ultrasonic transducer assembly 600 demonstrating an exemplary means of construction. The two halves 602, 612 are secured together by screws 660 which mate with threaded inserts 662. A channel around the parting line 624 is filled with grease or adhesive to form a watertight seal. Transducer arrays 604, 614 are attached to array backing printed circuit boards 104, 114 respectively. The array backing printed circuit boards 104, 114 provide electrical connection between elements assigned to the same channel. The array backing printed circuit boards can also incorporate passive electronic components such as series inductors to improve electrical matching between transducer arrays 604, 614 and transmit and receive electronics.

Array connectors 140A, 140B on the array backing printed circuit boards 104, 114 mate with headers 142A, 142B on transducer control printed circuit board 100. The headers 142A, 142B are angled between ±15 degrees and ±25 degrees from horizontal. The rationale for the angles is discussed below. Transducer arrays 604, 614 further comprise an acoustic matching structure. FIGS. 1A and 1B show the first of two acoustic matching layers already attached to the transducer arrays 604, 614. A first matching layer 1106A, 1106B attaches to array elements, and a second matching layer (not shown) attaches to the respective first matching layer 1106A, 1106B and contacts the water. The second matching layer is deposited as a resin and cured. Pour frames 607, 617 align to the array backing printed circuit boards 104, 114, and O-rings 605, 615 provide a seal around the first matching layers to prevent the liquid resin from seeping into the transducer arrays before the resin is cured. Once the resin is cured, it provides a watertight seal between the first matching layers 1106A, 1106B and the pour frames 607, 617. Openings 630A, 630B in the front half 602 and the back half 612 allow the second matching layer (not visible) to make contact with the water. Marine grade sealant such as urethane or silicone (not shown) provides a watertight seal between edges of the pour frames 607, 617 and edges of openings 630A, 630B. Cosmetic covers 603, 613 hide the seal. Interior walls 632A, 632B mark the end of an air gap behind the backing printed circuit boards 104, 114. The area above these walls can be filled with weights to increase the negative buoyancy of the transducer for improved stability in the water.

The transducer control printed circuit board 100 incorporates additional circuitry to perform ultrasonic imaging. An analog front-end integrated circuit provides signal conditioning and analog-to-digital conversion, described in more detail below. A pulser integrated circuit drives high voltage pulses to the array backing printed circuit boards 104, 114 according to transmit beamforming signals generated by a field-programmable gate array (FPGA). An orientation sensor is also provided to support three-dimensional ultrasound mapping as described below. Any of the known ways to measure orientation may be used. Magnetic field sensors may accurately detect the orientation of the multibeam transducer assembly within the earth's magnetic field. Improved accuracy and response time may be achieved by utilizing a multi-axis gyroscope and/or a multi-axis accelerometer. Combining information from multiple sensor types to improve performance, referred to as sensor fusion, can provide improved orientation accuracy and reduced response time. Products combining a three-axis gyroscope and three-axis accelerometer into a single package are often referred to as a 6-axis inertial measurement unit (IMU), and products that also include a three-axis magnetic field sensor are often referred to as a 9-axis IMU.

In the transducer assembly 600 of FIGS. 1A and 1B, power is delivered to the transducer control printed circuit board 100 through a communication cable (e.g., the cable 622), retrieved from center taps of communications transformer 124 and rectified. Additional switching and linear power supplies reside on the transducer control printed circuit board 100 but are not labeled for the sake of clarity. Generation of high voltage positive and negative power supplies for use by the pulser integrated circuit 116 may involve transformer 122 and high voltage capacitors 108, 118. Heat generated by the electronics is dissipated into the water through heat spreaders 150, 152 constructed from a combination of thermal pad material on both sides of a metal core. The heat spreaders 150, 152 reduce the thermal resistance between the transducer control printed circuit board 100 and the housing front half 602 and back half 612. The metal core also adds weight to the transducer assembly, which increases its negative buoyance and stabilizes its suspension in the water.

A thermistor 146 on transducer control printed circuit board 100 makes thermal contact with the water by being placed in close proximity to thermal screw 650 within a thermistor pocket 652. Thermal connection is increased by filling thermistor pocket 652 with a thermally conductive grease. The presence of water and the salinity of the water is determined by measuring the conductivity between two conductivity measurement screws 670. The conductivity measurement screws make electrical contact with the transducer control printed circuit board 100 through conductivity standoffs 672.

The frequencies and calculated target bandwidth shown in the table of FIG. 7A apply for a given sound velocity in water. In the table, such sound velocity is assumed to be 1500 m/s. However, depending on water conditions the sound velocity value can fall as low as 1400 m/s for cold, fresh water or rise above 1500 m/s for warm salt water. Factoring in adjustment of the transducer frequencies for these various sound velocities, the transducer bandwidth approaches 70%. Alternatively, a fixed set of frequencies can be used, and adjustments made to a display, to compensate for changes in beam angles resulting from changes in sound velocity.

FIG. 7B is a table of calculated frequencies and phases to achieve beam steering from 15 degrees to 65 degrees and from −15 degrees to −65 degrees, based on the transducer array parameters of FIG. 7A. The table of FIG. 7B provides 1 degree angular resolution. The frequencies in the table of FIG. 7B are calculated independently of how those frequencies might be achieved.

FIG. 7C is an alternative table of frequencies and phases to achieve beam steering angles from approximately 15 degrees to approximately 65 degrees and from approximately −15 degrees to approximately −65 degrees, where the frequencies are obtained by dividing a 500 MHz reference clock. In order to simplify the generation of phases in 45 degree increments, divisors can be chosen that are multiples of 8. This is achieved by first dividing the 500 MHz reference clock by a sub-divisor, and then dividing the subdivided clock by 8. The subdivided clock is useful for generation of pulser control signals with phase delays that are multiples of 45 degrees, as will be discussed below. Instead of targeting integer values of steering angles in degrees, consistent sub-divisor steps per phase can achieve more evenly spaced beams with more consistent overlap to ensure full coverage.

Using 8 channels with the frequencies and phases in FIG. 7C results in a region approximately ±15 degrees from directly broadside to the transducer array where no beams are transmitted or received. The region is equivalent to the gap 208 shown in FIG. 2A. For a second array to provide coverage in this gap area, the second array may be angled at least 30 degrees relative to the first array. For a system with two arrays, the arrays may be angled symmetrically positive and negative around a vertical reference angle. Accordingly, for this system, the minimum rotation angle of the two arrays is ±15 degrees. A maximum angle of rotation also exists beyond which the gap 208 would not be covered by the steering angle range 214 of the second array 212 as shown in FIG. 2B. This maximum angle is equal to one-half of the difference between a maximum and a minimum steering angle of the array 202. Using the maximum and minimum angles from FIG. 7C, the maximum rotation angle of the two arrays is approximately ±25 degrees. Using a larger number of channels with corresponding smaller minimum phase can decrease the size of the region directly broadside to the transducer array where no beams are transmitted or received such that relative rotation angle of the two arrays may be slightly smaller than ±15 degrees or slightly larger than ±25 degrees.

FIG. 7D shows a table of unique frequencies for steering the 8-channel array. The number of unique frequencies may be smaller than the number of beams, such that a same frequency is used at more than one phase to achieve different steering angles. Sonar systems may include an Analog to Digital Converter (ADC) which has a sample rate that is at least twice the maximum frequency of interest. The ADC sample rate for the exemplary 8-channel array can also be produced by dividing the same 500 MHz reference clock used to generate the operating frequencies. The divisor used for the ADC sample clock can be selected so that an integer number of samples occurs within a target number of cycles. For example, by choosing a frequency divisor of 64, for an ADC sample clock of 7.8125 MHz, this combines with the selection of frequency divisors for the beams that are a multiple of 8 to guarantee that every beam has an integer number of samples within 8 cycles. This relationship is demonstrated in the table of FIG. 7D, and the benefit of this for receive beamforming is that a windowing function may not be required if all returning echoes are known to have an even number of periods within their sampling window.

It should be understood that the example reference clock frequency shown above and the tables of frequencies in the preceding figures are applicable for a specific velocity of sound in water, which is 1,500 m/s for these examples. For operation in water with a different sound velocity, such as cold, fresh water, a different sound velocity may be used. The present teachings provide a system and method that adjusts the reference clock frequency proportionally to the sound velocity, thereby resulting in a new reference clock and new beam frequencies. For example, changing the speed of sound to 1,405 m/s can be compensated by changing the reference clock to be 468.33 MHz. Leaving all the divisors as specified in the table of FIG. 7C, the divided frequencies are automatically adjusted to produce beams at the correct angles.

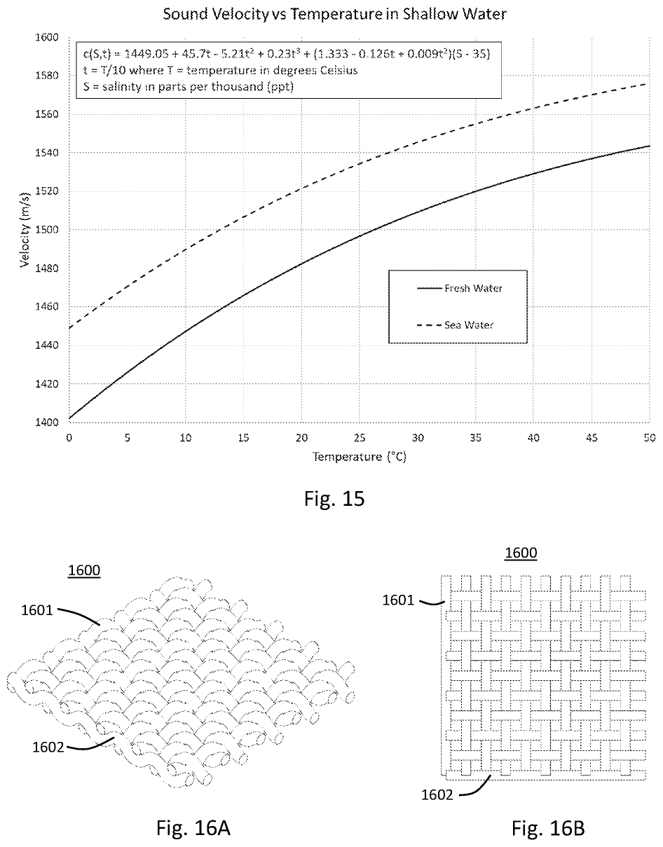

In another implementation, the reference clock frequency remains constant, and the steering angle of each beam is allowed to change as the sound velocity changes. In this implementation, the steering angles for each beam are recalculated when a change is detected in the sound velocity, and the updated steering angles are used by a display algorithm. In both the implementation that changes the reference clock based on sound velocity and the implementation that recalculates the steering angles based on sound velocity, the system may have a means for measuring, estimating, or entering sound velocity. For shallow water, where pressure has relatively little effect, sound velocity can be accurately estimated using Coppen's equation as shown in FIG. 15 if water temperature and salinity are known. Therefore, the present teachings provide a system that includes a water temperature sensor and a salinity sensor. The salinity sensor may measure the conductivity between two electrodes since the conductivity of water varies with salt concentration. The salinity sensor may be combined with a water immersion sensor. The system can use this water immersion sensor to halt transmission and reduce power consumption when the transducer is out of the water.

FIG. 7E schematically shows a top-down view of beams formed using the transducer parameters of the table of FIG. 7A and the frequencies and positive phases of the table of FIG. 7C. Each beam in FIG. 7E extends the same distance from the transducer location 701, and the extents of the beams correspond to the point at which the acoustic energy is 3 dB below the energy at the center of the beam. This is referred to as the 3 dB down point. The beams get wider in both the steering direction and perpendicular to the steering direction as the frequency decreases. Sudden changes in the beam widths correspond to shifts in the phase from 45 degrees 702 to 90 degrees 704 and from 90 degrees 704 to 135 degrees 706. The reduction in beam widths does not directly result from the change in phase, but rather corresponds to the increase in frequency associated with the change in phase. While the visualization of the beams in FIG. 7E accurately depicts the beam widths in the direction perpendicular to the steering direction, beam widths in the steering direction in FIG. 7E appear compressed due to the top-down perspective.

FIG. 7F is a graph that plots the beam widths in the steering direction and the beam widths perpendicular to the steering direction both versus steering angle, for the beams of FIG. 7E. The beam width in the electronic steering direction is labeled “Parallel,” and may be elsewhere referred to as the azimuth beam width. Similarly, the beam width perpendicular to the electronic steering direction is labeled “Perpendicular,” and may be elsewhere referred to as the elevation beam width. Separate vertical axes of the graph allow the two beam widths to be shown on the same graph. The beam width in the steering direction ranges from 1.1-3.1 degrees, while the beam width perpendicular to the steering direction ranges from 15-30 degrees.

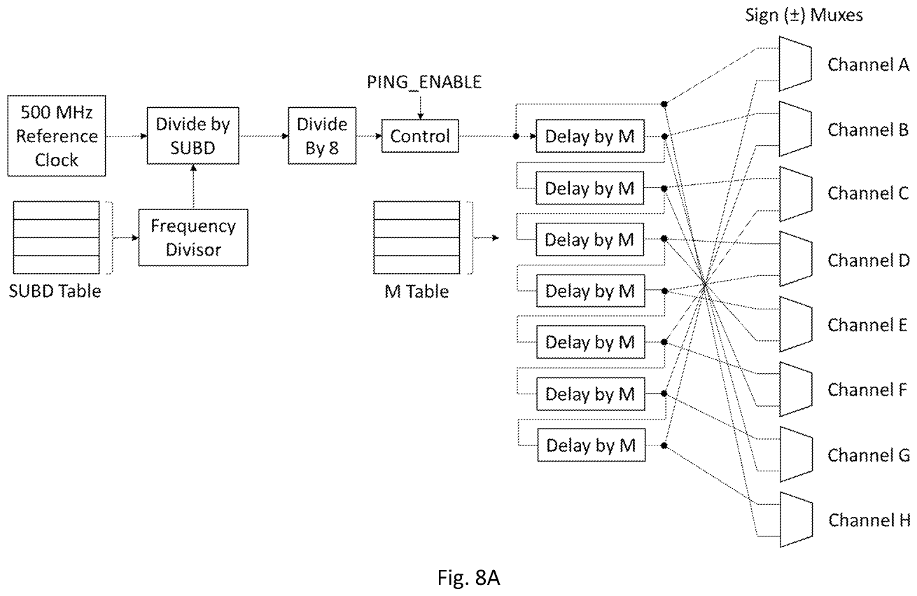

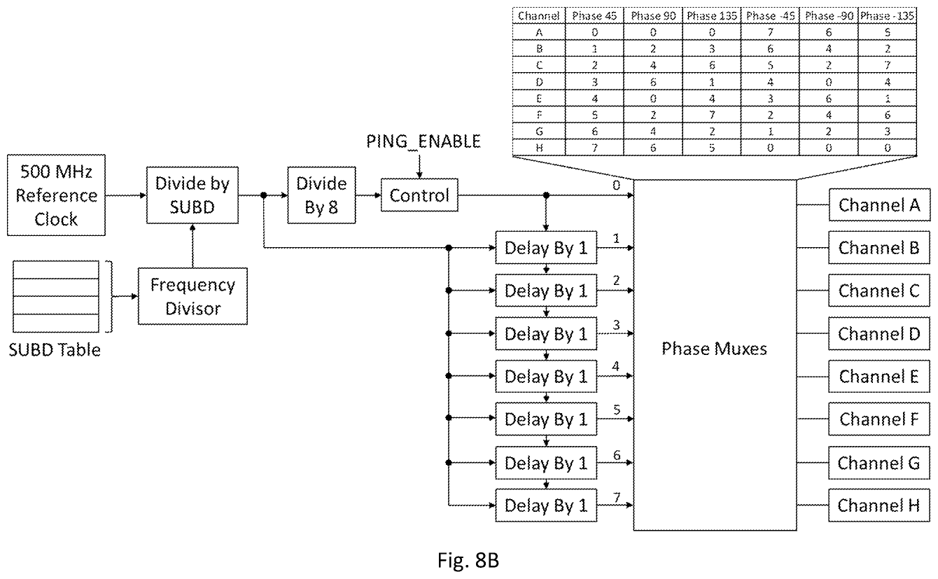

FIG. 8A is a flow diagram depicting devices and one method of transmit beamforming using sequential delays. The method involves generating eight different pulse control signals for an array configured to have eight electronic channels. A high frequency reference clock, for example a 500 MHz one, is initially divided by a frequency divisor. The frequency divisor is referred to herein as the sub-divisor or SUBD. This sub-divisor can be stored as entries in a table such as that shown in FIG. 8A, or it can be algorithmically generated. The subdivided frequency is eight times the beam frequency. Thus, the subdivided frequency is suitable for clocking logic that delays an incoming square wave at the beam frequency by different amounts that are multiples of one-eighth of the period, which is 45 degrees. The subdivided frequency is divided by eight to generate a clock signal that is at the target frequency for the beam. This beam frequency clock is fed into control logic, and the beam begins transmitting when a PING_ENABLE signal is active. The word “ping” refers historically to a sonar transmission and should be understood as a transmit enable for the beams in this context.

Once transmission is enabled, a clock at the beam frequency is sent from the control logic to a first sign multiplexor (or mux), to an eighth sign mux, and to an input of a first delay block. In the illustration, each of seven delay blocks is labeled “Delay by M.” The delay blocks may be logic blocks in a field programmable gate array (FPGA). An output of the first delay block is then sent to a second sign mux, to a seventh sign mux, and to an input of a second delay block. This pattern continues until a seventh delay block, whose output is sent to the eighth sign mux and to the first sign mux. The sign muxes compact the logic by allowing positive and negative phases, as depicted in FIGS. 4A-4F, to be generated from a single set of delay blocks. When the sign muxes are in one state, the transmit beamforming pulses begin with channel A and end with channel H. When the sign muxes are in the opposite state, the transmit beamforming pulses begin with channel H and end with channel A. The amount of delay in each delay block can be controlled by a table, where the value M shown in FIG. 8A refers to the number of subdivided clocks of delay between the input and output. In FIG. 8A, the table is labeled “M Table.”

It should be noted that the output of each channel is a square wave stream of pulses when the PING_ENABLE signal is active, and is zero at all other times. Square waves may be used to control the inputs of pulser circuits for transmit beamforming, due to their simple generation and inherent or designed filtering action of the pulser circuitry and transducer load. The transmit beamforming logic of FIG. 8A can be extended to generate control signals with lower harmonic content, by generating multiple signals per channel for a multi-level pulser or by generating multiple signals per channel for input to a digital to analog converter (DAC).

The transmit beamforming logic, shown in FIG. 8B, wraps the phase delay for each channel into an equivalent angle between 0 and 360 degrees. The eight different versions of the clock are generated at 45 degree increments, and the input for each channel is selected based on the multiplexing table shown at the top of FIG. 8B.

Receive beamforming can be accomplished in a variety of ways. Most wide bandwidth receive beamformers start by taking the input signal from analog to digital converters and performing a windowed short-time Fast Fourier Transform (FFT). A windowing function may be applied to drive the signal to zero at the start and end of the window, to avoid artifacts due to discontinuities at the edges of the window. Furthermore, overlap is used to make up for the signal suppressed by the windowing function. In a large percentage of FFT applications, the magnitude information is used, and the phase information is ignored. For the frequency and phase steering approach described herein, however, the phase information of the FFT may be used to distinguish between different beams at the same frequency but different phases. Additionally, the frequency bin size of an FFT is determined by the number of samples, and extends from 0 Hz up to one half the sampling frequency. The evenly spaced bins of an FFT may involve mapping into the discrete frequency steps used by each beam. In order to utilize more FFT bins, the received signal may be mixed with an intermediate frequency and the output of the mixer fed through a low-pass filter to remove frequency sum components, leaving frequency difference components extend down to frequencies nearer to 0 Hz. The low-pass filter may also apply decimation to lower the sample frequency used in subsequent signal processing.

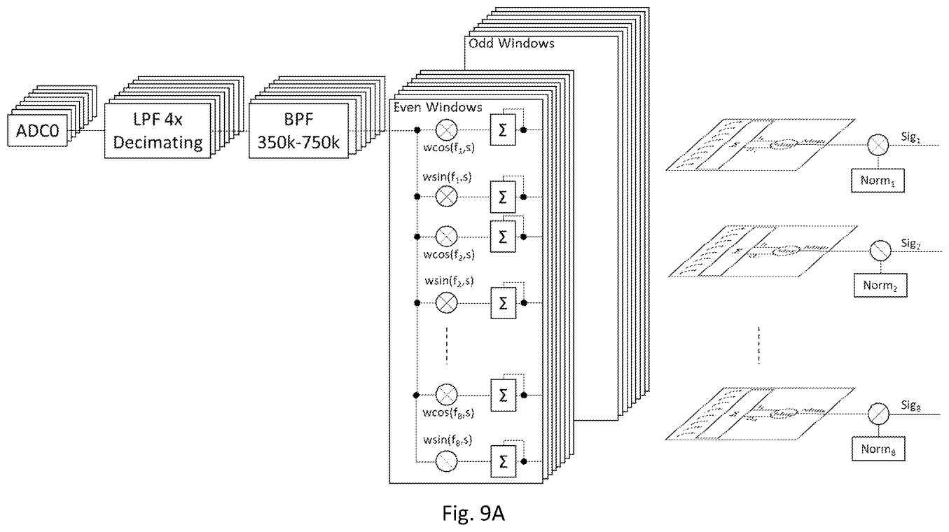

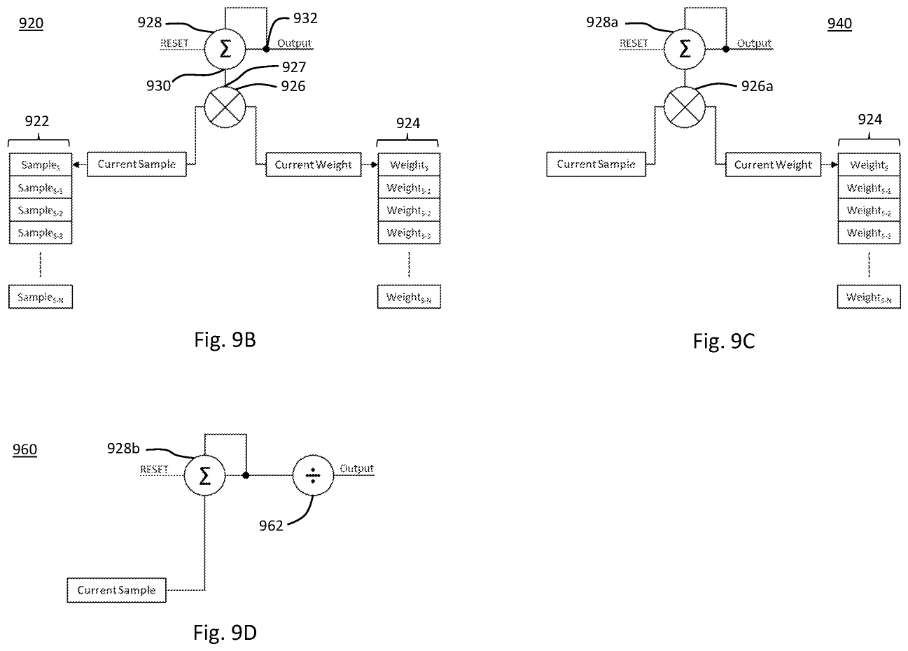

FIG. 9A is a flow diagram depicting devices and one method of receive beamforming, based upon digital In phase-Quadrature (I-Q) demodulation at discrete frequencies corresponding to the frequencies used for the transmit beamforming. Each channel A-H (see FIG. 8B) can be connected to an analog front-end (not shown) to amplify the weak return signals and apply time-varied-gain or time-varied-attenuation to reduce the dynamic range of the channel signal. The output of the analog front-end for channels A-H is connected to analog to digital converters ADC0-ADC7 respectively, to digitize the conditioned signals for each channel. The ADCs can be integrated with the analog front-end or reside on a separate integrated circuit. The sampled digital signal may undergo one or more stages of filtering prior to I-Q demodulation. FIG. 9A shows use of a low-pass filter (LPF) and a band-pass filter (BPF). The LPF attenuates frequencies above the maximum sonar frequency, which may be generated by the system or received from external sources such as AM radio. Decimation, also known as down sampling, may be applied after or as part of a filter stage to lower the sample rate of the data. The LPF filter also serves as an anti-aliasing filter for decimation. One benefit of reducing the sample rate is allowing the same physical digital signal processing blocks to be used for multiple channels or multiple beams by running digital signal processing at a clock rate that is higher than the sample rate. The BPF attenuates frequencies above and below the sonar frequency range. The LPF and BPF can be useful to prevent high-amplitude interference sources from saturating subsequent stages of the I-Q demodulators.

Signal processing logic retrieves the digitized signal from each of the eight filtered channels, and routes the signal for each channel to a series of digital I-Q demodulators, each of which includes a pair of digital I-Q mixers and a pair of accumulator blocks, which act as low-pass filters. I-Q demodulation has been used in radio frequency analog signal processing. The letter “I” refers to signals that are “in phase” with the carrier signal, and may be represented as a cosine waveform, herein abbreviated “cos.” The letter “Q” refers to signals that are in “quadrature” with the carrier signal, meaning one-quarter wavelength behind. These signals may be represented as a sine waveform, herein abbreviated “sin.” The cosine and sine functions can be pre-multiplied by a windowing function to eliminate continual performance of the windowing function multiplication. In FIG. 9A, “w cos” refers to a windowed cosine function, and “w sin” refers to a windowed sine function. In practice, these functions may be stored in memory and serve as templates that the incoming channel signals are mixed with to implement a matched filter. Each mixer can be implemented in logic as a multiplication and produces an output, which includes frequencies at a sum of the two input frequencies and at a difference between the two input frequencies. The number of mixers for full parallel processing is equal to twice the number of channels multiplied by the number of unique frequencies. In the exemplary case of 8 channels per array and 41 unique frequencies as listed in FIG. 7D, a total of 656 mixers would be used for full parallel processing of an array. This number increases to 1,312 mixers when overlapping even and odd windows are used as shown in FIG. 9A. In practice, the digital signal processing clock rate may be higher than the sample rate, and the same multiplication block may be used for multiple different channels and/or multiple different frequencies.

The output of each mixer is sent to an accumulator block, labeled with the Greek letter Sigma (Σ) in FIG. 9A. The accumulator block acts as a low-pass filter, isolating the DC component of the mixer output, which is proportional to the amplitude of the input signal at the frequency of the cosine or sine input to the mixer and is scaled by the phase of the input signal relative to the cosine or sine input to the mixer. If window overlap is used, and accumulators are used as low-pass filters, as shown in FIG. 9A, a separate set of matched filters is used since the next window may start accumulating before the previous window is complete. One set of matched filters is used for even windows and a second set of matched filters is used for odd windows. Other known low-pass filters may be used such as a finite impulse response (FIR) filter, depicted in FIG. 9B, a down-sampling FIR filter, depicted in FIG. 9C, or a down-sampling averaging filter, depicted in FIG. 9D.

A FIR filter 920, schematically represented in FIG. 9B, may use a number of samples stored in a sample history memory 922, a matching number of weights 924, a multiplier 926, and an accumulator 928. As each new sample is received, the accumulator 928 is reset. One input 930 of the accumulator 928 is connected to an output 927 of the multiplier 926, which multiplies a sample from sample history memory Sample s-N to Samples by a corresponding weight from Weight_{S-N} to Weight_{S} respectively. The multiplication is repeated for each sample, weight pair with the product (e.g., the output 927) being added to the previous output 932 of the accumulator. When all samples have been multiplied by their corresponding weight and added to the accumulator, the output 932 of the accumulator 928 equals a filtered output for the current sample. Such filters provide multiplication and accumulation (summation) computations during each sample period, and these computations may be performed by digital signal processing (DSP) blocks in a microprocessor or FPGA. Decimation can be applied to the FIR filter 920 to produce an output at a lower sample rate than the input sample rate. To avoid aliasing, the new sample rate after decimation may be greater than twice the filter stop frequency.

If the temporal (time) resolution of an ultrasonic system is significantly lower than the sample rate, a down-sampling FIR filter 940 can be used as is schematically represented in FIG. 9C. Unlike the FIR filter, which produces a new output for every sample, the down-sampling FIR filter produces a new output every N+1 samples. One multiplication operation is involved for each sample, so multiplier 926a and accumulator 928a each perform one computation per sample compared to N+1 computations per sample for the FIR filter. Furthermore, no sample history memory is involved.

In some implementations, a down-sampling FIR filter may be a simple averaging filter 960 as schematically represented in FIG. 9D. A simple averaging filter uses the same weight for all samples, so no multiplication by weights is involved. The accumulator 928b is reset and each current sample is added to the accumulator 928b until a number of samples to average is reached. A divider 962 then divides the output of the accumulator 928b by the number of samples to compute an output equal to an average of the samples. Digital gain can be applied in an averaging filter by using a divisor that is smaller than the number of samples, or by omitting use of the divider.

The output of the accumulators in FIG. 9A for each channel plus frequency combination is a pair of numbers representing the in-phase and quadrature components of the signal for the given channel at the given frequency. Since the transmit beamforming utilizes phase delays between adjacent channels to steer the beam, the receive beamforming may also apply phase delays between adjacent channels. These phase delays are implemented as rotations of the I and Q values for each channel. More than one phase rotation can be used at a given frequency, so each channel plus frequency combination can feed into multiple I-Q phase rotators. I-Q phase rotation performs a linear transformation and produces new I and Q coefficients associated with the rotated signal. Phase rotations greater than 360 degrees can be wrapped into an equivalent angle between 0 and 360 degrees.

The next stage of receive beamforming in FIG. 9A involves using beamforming summation blocks to sum the rotated I-Q signals from each channel plus frequency combination to form each beam. The summation results in final values designated as I_{B} and Q_{B} for each beam, capturing the magnitude and phase of the return from that beam at that time. I_{B} and Q_{B} can be transmitted to the display unit. Alternatively, the magnitude of each beam can be calculated as the square root of the sum of the squares of I_{B} and Q_{B}. A plurality of magnitude calculation blocks can be provided for this purpose. In FIG. 9A, such magnitude calculation blocks are shown, and are abbreviated as “Mag.” In an example implementation, the magnitude calculation blocks are logic blocks in a field programmable gate array (FPGA). Each magnitude calculation block produces an output that is proportional to signal strength from the beam and is independent of signal phase, whereas the I_{B} and Q_{B} values can be lower than the signal strength or even zero depending on signal phase. For two-dimensional real-time imaging applications, having the signal processing logic in the transducer assembly perform the magnitude calculations minimizes the signal processing that is left to the display unit. For three-dimensional mapping, however, maintaining the individual I_{B} and Q_{B} values for each beam enables phase-inclusive synthetic aperture techniques (see below).

In practice, beams at different frequencies and phases are transmitted and received at different relative strengths. Therefore, it is beneficial to normalize the signal by multiplying each beam magnitude “Mag B” by a normalization factor “Norm B” to calculate the final signal “Sig B” for each beam.

As discussed previously for transmit beamforming, the reference clock frequency can be adjusted to account for changes of the speed of sound in water. Since the template cosine and sine waveforms used in the I-Q demodulators are based on samples, and the sample frequency is derived from the reference clock, no other changes are involved.

The overlap between steering angle ranges 206 and 214 shown in FIG. 2C creates an opportunity to use targets directly below the transducer assembly to calibrate the reference clock for the speed of sound. When the speed of sound is set properly, objects below the transducer appear in the same location whether they were detected with array 212 or array 202. If the speed of sound is not set properly, objects below the transducer appear in two locations or appear to be widened. This behavior can be integrated into a speed-of-sound calibration workflow. Alternatively, the speed of sound can be estimated based on measurement of water temperature and salinity as described previously.

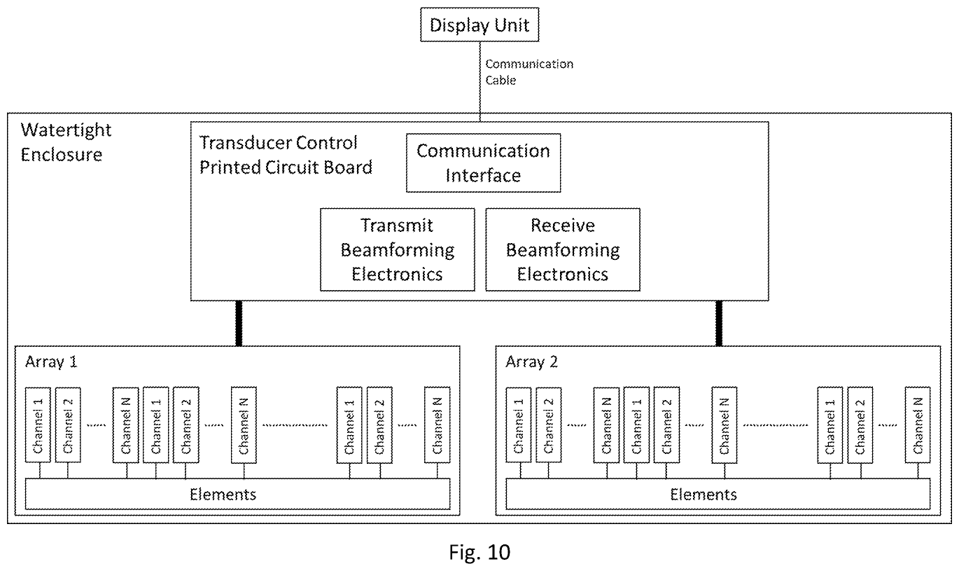

FIG. 10 is a block diagram of the transducer assembly 600. A watertight enclosure houses two arrays and a transducer control printed circuit board (PCB). Each array includes a number of elements, which are electrically connected to a number of channels that is less than the number of elements. The channels from each array are connected to the transducer control printed circuit board, which includes transmit beamforming electronics, receive beamforming electronics and a communication interface. The transmit beamforming electronics may include logic circuitry in an FPGA or microprocessor and a pulser circuit for each channel. The receive beamforming electronics may include an analog front-end for each channel and digital signal processing circuitry in an FPGA or microprocessor. Additional support circuitry can be included on the transducer control printed circuit board such as, but not limited to, power supplies and memory chips; but these are omitted from the illustration for clarity. The communication interface connects to an external display unit through a communication cable, which can also deliver power to the transducer control printed circuit board.

A primary goal for two-dimensional real-time imaging sonar systems is to minimize latency between when a signal resulting from an echo is received and when a display of the sonar system is updated. The receive beamforming depicted in FIG. 9A can be implemented using parallel signal processing circuitry such that multiple beams can be processed in parallel, and the signal processing occurs at the same rate as data sampling. That is, the receive beamforming calculations are completed for each beam before the next sample is ready from each channel. A signal processing pipeline for each beam can be established such that data flows continuously from the ADC to the I-Q mixers, and into the accumulators, phase rotators, beamforming summation, and normalization blocks. The accumulator blocks, which act upon a plurality of samples, provide the majority of signal processing latency, while the ADC, I-Q mixers, phase rotators, beamforming summation blocks and magnitude calculation each can be implemented with low latency.

The output of the signal processing pipeline for each beam is periodically sampled, and represents the intensity of sound returning from the steering direction of each beam at that point in time. The sampled output for each beam is transferred to the display unit via the communication interface. To minimize latency, the communication interface transmits the sampled outputs for each beam as soon as possible after they become available. The communication interface transmits current processed data to the display unit while the next sample is being processed. Latency is minimized by the communication interfacing operating at a high data rate that allows the sampled outputs for all beams to be transmitted to the display unit before the next sampled output is available.

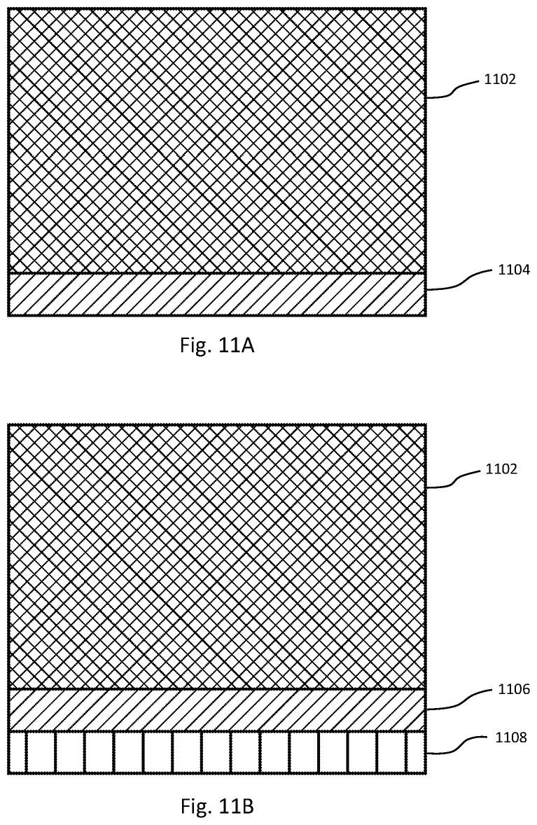

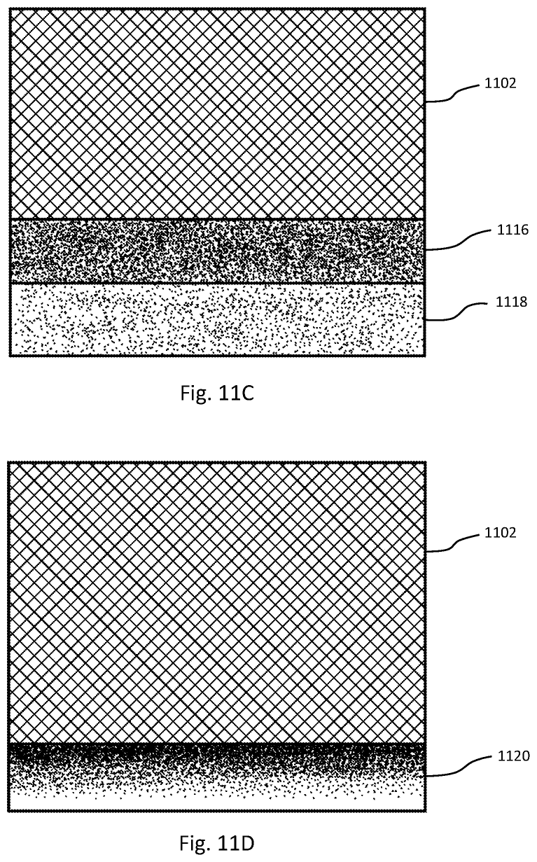

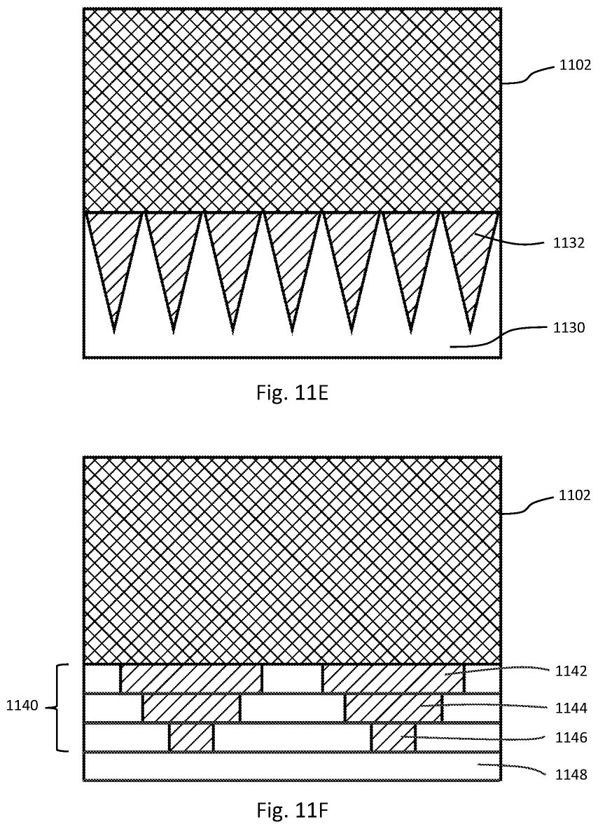

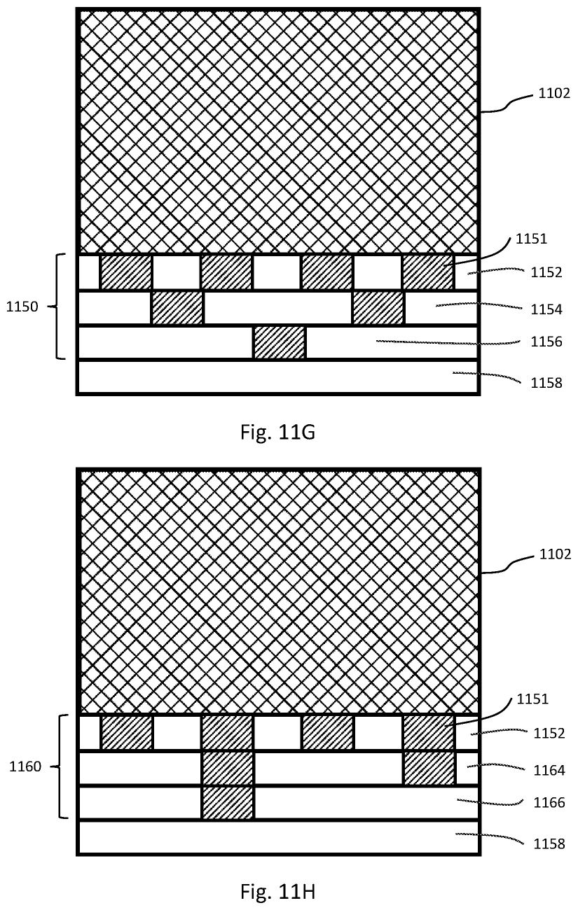

Ultrasonic piezoelectric transducer elements may have an acoustic impedance that is significantly higher than the acoustic impedance of water. For this reason, ultrasonic piezoelectric transducers often incorporate one or two acoustic matching layers between the piezoelectric elements and the water. Such acoustic matching layers can also provide electrical isolation. FIG. 11A is a schematic, cross-sectional view of part of a piezoelectric transducer, showing use of a single matching layer 1104 between a piezoelectric element 1102 and water. A single matching layer reduces reflections as compared to using no matching layer, and consequently increases the amount of signal transmitted into the water from the piezoelectric element 1102 and transmitted into the piezoelectric element 1102 from the water. However, signal reflections still occur at the interface between the piezoelectric element 1102 and the matching layer 1104, and at the interface between the matching layer 1104 and the water. To maximize the amount of sound transmitted into the water, single frequency ultrasonic systems may utilize a matching layer 1104 that is one-quarter wavelength thick, such that the reflected signals add in phase with the direct signals. For wide bandwidth systems, however, quarter wavelength matching is less effective as the wavelength changes as a function of frequency.

FIG. 11B is a schematic, cross-sectional view of part of a piezoelectric transducer with a two-layer matching structure used in wide bandwidth systems. The use of two layers allows a more gradual change in acoustic impedance between the piezoelectric element 1102 and a first matching layer 1106, between the first matching layer 1106 and a second matching layer 1108, and between the second matching layer 1108 and the water. A two-layer matching structure with properly selected acoustic impedance provides a larger directly transmitted signal. Larger numbers of matching layers may be used. However, a larger number of matching layers may result in greater attenuation due to thickening of the matching structure.

Acoustic matching layers with target acoustic impedances are often produced by mixing a powdered form of a high acoustic impedance material into a low acoustic impedance material while the low acoustic impedance material is in its liquid form. FIG. 11C is a schematic, cross-sectional view of part of another piezoelectric transducer with another kind of two-layer matching structure. The matching structure includes a first matching layer 1116 that has a relatively high volume density of a material with a high acoustic impedance, and a second matching layer 1118 that has a relatively low volume density of the material with a high acoustic impedance.

FIG. 11D depicts a schematic, cross-sectional view of part of a piezoelectric transducer with a gradient acoustic matching layer. This approach uses a matching layer that has a gradient in the volume-density of a high acoustic impedance material through the thickness of a matching layer 1120. The volume-density of the high acoustic impedance material is highest at the surface which contacts the piezoelectric element 1102, and lowest at the surface which contacts the water. The matching layer 1120 can be produced by mixing a powdered form of a high acoustic impedance material into a low acoustic impedance material while the low acoustic impedance material is in its liquid form. In such case, a grain size of the powder is less than one-tenth the minimum wavelength of sound output by the piezoelectric element 1102.

FIG. 11E is a schematic, cross-sectional view of part of a piezoelectric transducer with a metamaterial acoustic matching structure, showing a simplified concept of the matching structure. Three-dimensional structures, significantly smaller than a wavelength, are formed by etching or molding a base structure. The three-dimensional structures are made of a first material 1132 that has a relatively high acoustic impedance, for example glass. Gaps between and around the three-dimensional structures are then filled with a second material 1130 that has a relatively low acoustic impedance. This combination of the three-dimensional structures and the second material 1130 constitutes the metamaterial. If the three-dimensional structures are small enough, the metamaterial behaves like a single material that exhibits an acoustic impedance gradient between the piezoelectric element 1102 and the water. The acoustic metamaterial of FIG. 11E could also be constructed by patterning three-dimensional structures into a material with relatively low acoustic impedance (e.g., the second material 1130) and filling the structures with a material that has a relatively high acoustic impedance (e.g., the first material 1132).

To facilitate low-cost production of an acoustic metamaterial, the present teachings may use manufacturing processes that are already available for the production of electronics. For example, the production of printed circuit boards with high density interconnects involves precise drilling of small holes, and can include filling of those holes with copper or other material. The substrate material for printed circuit boards is itself a composite material including epoxy impregnated with glass fibers. The intermediate acoustic impedance of Flame Retardant fiber glass epoxy (FR-4) printed circuit board material (approximately 6.6 MRayl) makes it usable as a single layer matching material. It is also usable as a base material for a metamaterial matching layer with greater than 6.6 MRayl acoustic impedance. The high acoustic impedance of copper (41.6 MRayl) makes it a candidate for use as a high acoustic impedance material in a metamaterial.

FIG. 11F is a schematic, cross-sectional view of part of a piezoelectric transducer with a metamaterial acoustic matching structure including discrete sub-layers with varying volume of material drilled out from one material and replaced by a second material. The illustration shows a piezoelectric element 1102 with an acoustic matching structure including a four-layer printed circuit board 1140 and another matching layer 1148 in contact with the water. The printed circuit board 1140 has four thin layers of copper separated by three sub-layers of FR-4 or similar material. Holes of different sizes are drilled in each sub-layer of FR-4 and filled with a high acoustic impedance material such as copper. The FR-4 sub-layer 1142 closest to the piezoelectric element 1102 has the highest volume density of copper, the middle FR-4 sub-layer 1144 has a lower volume density of copper, and the bottom FR-4 sub-layer 1146 has the lowest volume density of copper. The bottom FR-4 sub-layer 1146 can have no holes and no copper fill in some implementations. In the specific case of FR-4, there remains an acoustic impedance mismatch between the FR-4 material and the water, so an external matching layer 1148 can optionally be used. The additional external matching layer 1148 is used to step between the acoustic impedance of the bottom FR-4 sub-layer 1146 and the acoustic impedance of the water.

For alternative substrates with lower acoustic impedance, an external matching layer may be omitted. The use of FR-4 material and copper-filled holes, known as vias, is one exemplary case. The general concept of discrete sub-layers of drilled and filled material can be applied to other materials. Additionally, filling of the holes can happen during the processing of each discrete sub-layer, or the holes can remain open and be filled after the sub-layers are pressed together. The substrate may be a high acoustic impedance material, in which case holes of differing size would be filled with a material that has a lower acoustic impedance. Finally, the specific case of a four-layer printed circuit board 1140 is presented as an example, and a different number of sub-layers can be used without changing the fundamental concept.

For an acoustic metamaterial to behave like a bulk material with acoustic properties in between the acoustic properties of its constituents, the feature sizes may be much smaller than the wavelength of the sound. In the manufacturing of printed circuit boards with high density interconnect (HDI), the smallest holes produced are referred to as microvias and may be laser drilled. To facilitate process control, all microvias in a given sub-layer may be made the same size.

FIG. 11G is a schematic, cross-sectional view of part of a piezoelectric transducer with a metamaterial acoustic matching structure including discrete sub-layers with filled holes having a common diameter. The illustration shows a piezoelectric element 1102 with an acoustic matching structure. The acoustic matching structure includes a four-layer printed circuit board 1150, and a matching layer 1158 in contact with the water. The printed circuit board 1150 has four thin layers of copper separated by three sub-layers 1152, 1154, 1156 of FR-4 or similar material. Holes 1151 of consistent size are drilled in each FR-4 sub-layer 1152, 1154, 1156, and are filled with a high acoustic impedance material such as copper. The FR-4 sub-layer 1152 closest to the piezoelectric element 1102 has the highest number of holes per unit area, the middle FR-4 sub-layer 1154 has a lower number of holes per unit area, and the bottom FR-4 sub-layer 1156 has the lowest number of holes per unit area. The bottom FR-4 sub-layer 1156 can have no holes and no copper fill in some implementations. An additional external matching layer 1158 can be used to step between the acoustic impedance of the bottom FR-4 sub-layer 1156 and the acoustic impedance of the water.

FIG. 11H is a schematic, cross-sectional view of part of a piezoelectric transducer with a metamaterial acoustic matching structure including discrete sub-layers with aligned filled holes having a common diameter. The illustration shows a four-layer printed circuit board 1160 with an alternative arrangement of holes compared to the printed circuit board 1150 of FIG. 11G. In the printed circuit board 1160, holes 1151 in a middle FR-4 sub-layer 1164 are aligned with certain holes 1151 in a top FR-4 sub-layer 1152, and holes 1151 in a bottom FR-4 sub-layer 1166 are aligned with certain holes 1151 in the middle FR-4 sub-layer 1164 and the top FR-4 sub-layer 1152. This configuration allows the holes 1151 to either be drilled separately for each FR-4 sub-layer 1152, 1164, 1166, or be drilled from the top FR-4 sub-layer 1152 to different depths.

In the preceding FIGS. 11F-11H, the example use of FR-4 as the substrate material results in desirability for a final matching layer 1148 or 1158 at the water interface. FIG. 11I is a schematic, cross-sectional view of part of a piezoelectric transducer with an acoustic matching structure having a metamaterial first layer and an acoustic impedance gradient second layer. The piezoelectric transducer is similar to the piezoelectric transducer of FIG. 11G. However, a final matching layer is implemented as an acoustic impedance gradient matching layer 1170. Unlike the piezoelectric transducer of FIG. 11D which involves a gradient of the matching layer 1120 to step down the acoustic impedance from the piezoelectric element 1102 to the water, the gradient matching layer 1170 the acoustic impedance is stepped down from the bottom FR-4 sub-layer 1156 to the water.

Another approach that can be used to construct a metamaterial that exhibits acoustic impedance that gradually changes from a relatively high acoustic impedance at a first side to a relatively low acoustic impedance at a second side involves use of mesh materials. FIGS. 16A and 16B demonstrate an isometric and top-down view respectively of a woven mesh 1600. The mesh may include wires, threads, fibers, or bundles of fibers running in orthogonal directions which are often referred to as warp 1601 and weft 1602. Many different materials are sold as meshes. Metallic wire meshes such as steel, brass, copper, and aluminum contribute high acoustic impedance in the range of 15-45 MRayl. Glass fibers within fiberglass meshes contribute medium acoustic impedance in the range of 8-15 MRayl. Nylon and other plastic meshes contribute low acoustic impedance in the range of 2-8 MRayl. Any of these wire meshes can be infused with a resin material and cured to create a thin layer of material that has an effective acoustic impedance in between that of the mesh and the resin.

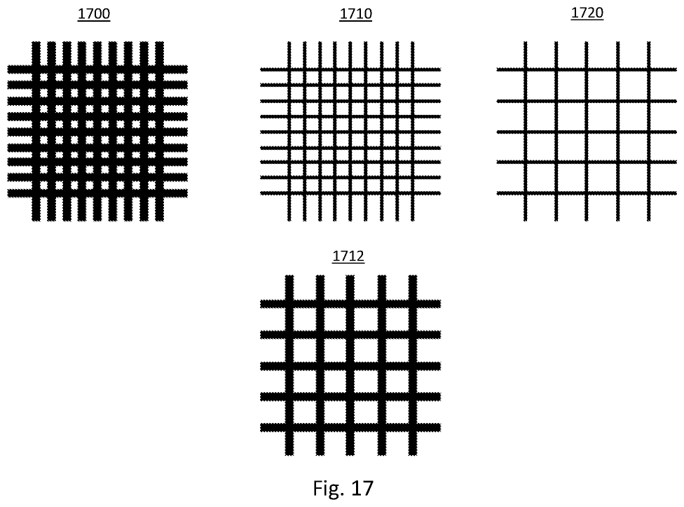

FIG. 17 depicts different mesh sizes that vary in wire size, mesh size, and open area. A small mesh size with wire size that is a significant fraction of the mesh size 1700 will have an effective acoustic impedance that is closer to the acoustic impedance of the mesh material than of the resin. A larger mesh size with small wire size relative to the mesh size 1720 will have an effective acoustic impedance that is closer to the acoustic impedance of the resin. Intermediate acoustic impedance values can be obtained using a smaller wire diameter as in 1710 or a larger mesh size as in 1712. The metamaterial constructed from the wire mesh and the resin is expected to behave like a bulk composite material when the pitch of the wire mesh is less than approximately one-tenth the wavelength of sound. Multiple layers of mesh material can be stacked in descending or ascending order by acoustic impedance. For example, one or more layers of metal wire mesh 1700 could be followed by one or more layers of mesh 1712 followed by one or more layers of mesh 1720 to build up a gradient matching layer with a desired thickness. The material of the mesh could also be changed between layers. For example, aluminum wire mesh would exhibit lower acoustic impedance than copper wire mesh with the same wire size and mesh size. Layers of non-metal materials such as fiberglass and nylon could also be incorporated. The stack of mesh materials can then be vacuum infused with a resin material to displace all air in the stack and to adhere the stack together.

Having established the foundational concepts for a multibeam ultrasonic transducer assembly capable of near real-time two-dimensional imaging, the transducer assembly can be enhanced and integrated into a system capable of three-dimensional mapping of objects.

In the case of ice-fishing, it is desirable for fishermen to be able to use sonar to scout the area beneath and surrounding a hole they have drilled in the ice. If no fish are observed directly below the hole, it is desirable to know the position of fish observed off to the side of the hole. An ideal ice-fishing sonar would tell the fishermen if any fish were beneath the hole; and if not, provide an accurate location of fish detected off to the side of the hole. Once a hole is drilled with fish beneath it, the ideal ice-fishing sonar can be switched into a near real-time imaging mode to allow the fishermen to observe how the fish respond to their bait or lure.

To accurately determine the position of a fish off to the side of the transducer assembly, three pieces of information may be collected; namely, distance, steering angle and heading angle. The transducer assembly may provide accurate distance and steering angle, but it does so over a narrow range of heading angles. Furthermore, the relatively wide beam width perpendicular to the electronic steering direction creates ambiguity in the heading angle. Therefore, it is useful to take further measures to provide an accurate heading angle, and in turn provide an accurate location of fish or other targets of interest.

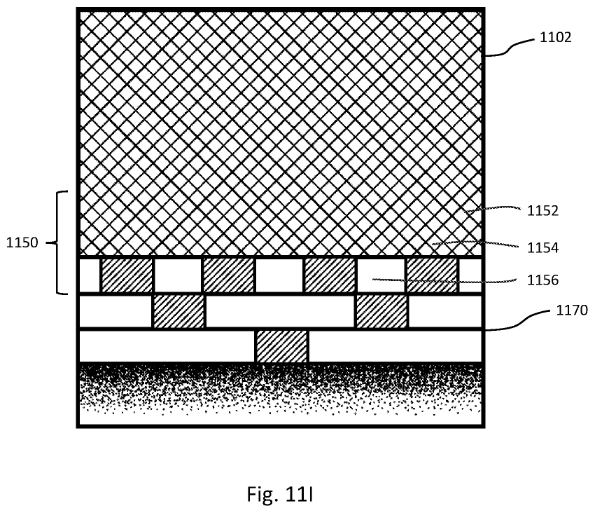

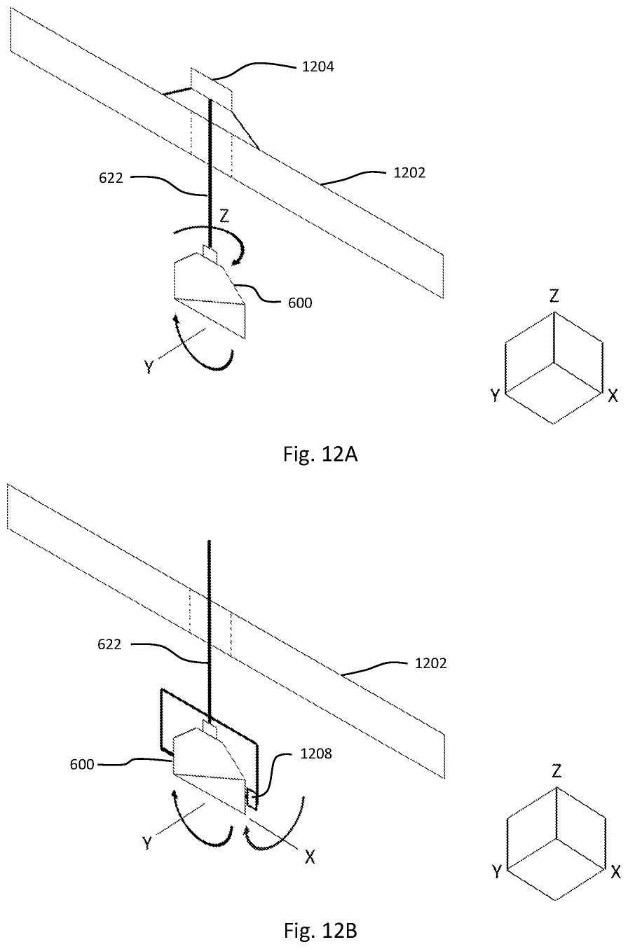

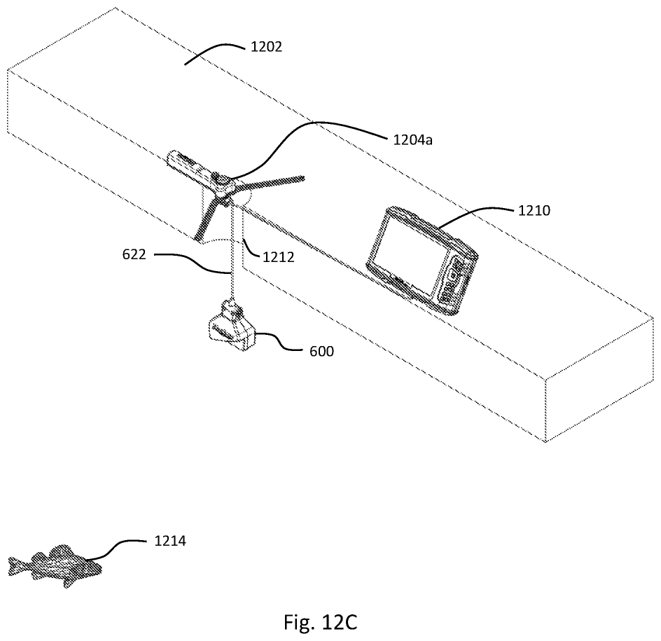

To cover all the area surrounding the transducer assembly, the transducer assembly may be rotated around an axis that is perpendicular to the axis of electronic steering. That is, a three-dimensional ultrasonic mapping system may be employed. FIG. 12A and FIG. 12B depict two exemplary ways to achieve the transducer assembly rotation. FIGS. 12A and 12B show a schematic, isometric view of the transducer assembly 600 suspended below a stationary platform 1202 (e.g., ice). The transducer assembly 600 is schematically shown on a two-dimensional plane for better understanding. X, Y and Z axes are defined in FIGS. 12A and 12B to facilitate understanding.

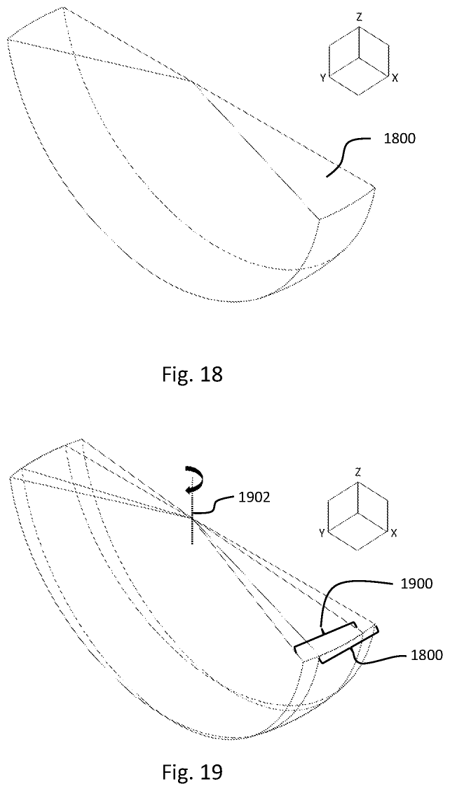

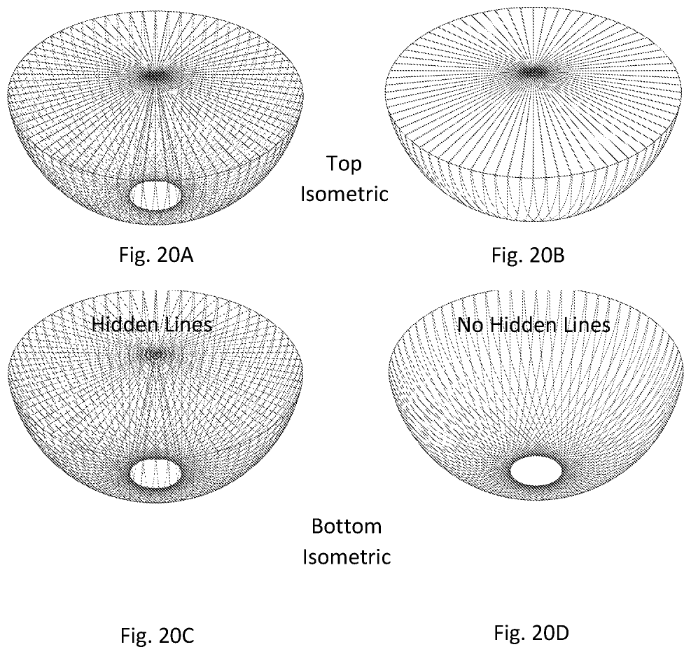

In FIG. 12A and FIG. 12B, the electronic steering occurs around the Y axis, which is parallel to a water surface and perpendicular to a plane of the transducer arrays. In FIG. 12A, a horizontal cable rotator 1204 provides rotation around the Z axis by applying a torque to the cable 622 which is coupled into the transducer assembly 600. Rotation of the transducer assembly 600 through 180 degrees around the Z axis is sufficient to create a three-dimensional map of a volume of water that covers 360 degrees around the Z axis. FIG. 18 shows an isometric view of an approximate shape of an area of water 1800 covered by a sonar beam set of the present transducer arrays. The coverage area is simplified to show a spherical sector spanning 160 degrees around a Y axis and 20 degrees around an X axis. FIG. 19 shows two partially overlapping areas of water 1800, 1900 covered by two sonar beam sets, where a rotation of 5 degrees around a Z axis 1902 has occurred between beam sets. Hidden lines are shown to help visualize the beam sets in three dimensions. FIGS. 20A through 20D show the coverage area of 36 beam sets where an additional 5 degree rotation around the Z axis occurs between each beam set as in FIG. 19. The combined coverage areas are shown from a top corner isometric view with hidden lines in FIG. 20A and without hidden lines in FIG. 20B. The combined coverage areas are shown from a bottom corner isometric view with hidden lines in FIG. 20C and without hidden lines in FIG. 20D. The 36 beam sets spaced every 5 degrees corresponds to 180 degrees of rotation. In this manner, complete coverage of 360 degrees around the Z axis is accomplished with 180 degrees of rotation of the transducer arrays.

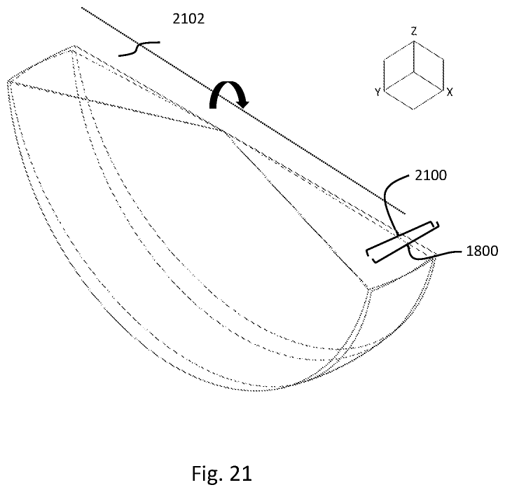

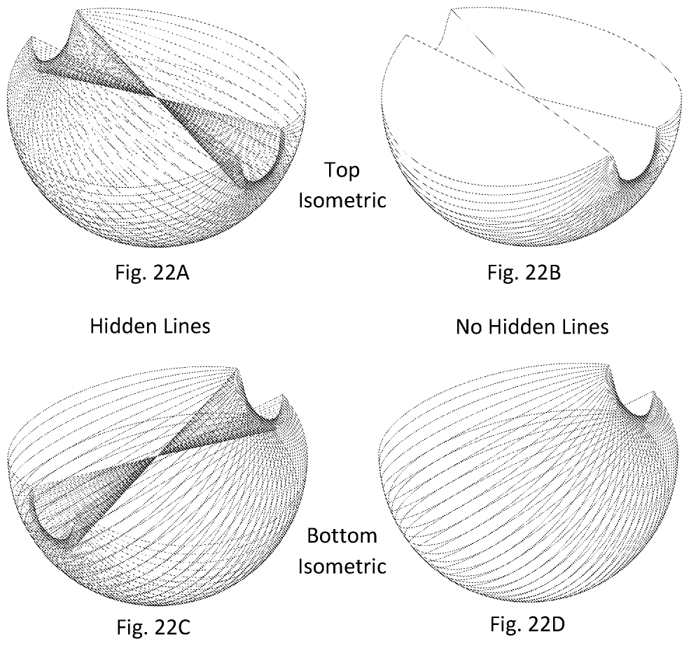

In FIG. 12B, a vertical transducer assembly rotator 1208 provides rotation of the transducer assembly 600 around the X axis, which is parallel to the water surface and in the plane of the transducer arrays. Rotation of the transducer assembly 600 around the X axis through an angle equal to the steering angle range is sufficient to create a three-dimensional map of a volume of water that covers 360 degrees around the Z axis. In one example the angle equal to the steering angle range is an angle of at least 160 degrees. Referencing again the simplified coverage area in FIG. 18, FIG. 21 shows two partially overlapping areas of water 1800, 2100 covered by two sonar beam sets, where a rotation of 5 degrees around an X axis 2102 has occurred between beam sets. Hidden lines are shown to help visualize the beam sets in three dimensions. FIGS. 22A through 22D show the coverage area of 31 beam sets formed by rotating the transducer array around the X axis from −75 degrees to +75 degrees in 5 degree increments. The combined coverage areas are shown from a top corner isometric view with hidden lines in FIG. 22A and without hidden lines in FIG. 22B. The combined coverage areas are shown from a bottom corner isometric view with hidden lines in FIG. 22C and without hidden lines in FIG. 22D. In this manner, complete coverage of 360 degrees around the Z axis is accomplished with less than 160 degrees of rotation of the transducer arrays.

FIG. 12C is a schematic, isometric rendering of a three-dimensional mapping system in the exemplary application of ice-fishing. In this application, a sheet of ice serves as the stationary platform 1202, and a hole 1212 is drilled into the ice to provide access to water beneath. The three-dimensional mapping system comprises the transducer assembly 600 modified to include an orientation sensor (see below). The transducer assembly 600 is coupled to a digital computer 1210 through the cable 622. The horizontal cable rotator 1204a in this example is a panner device, such as the MarCum Technologies CP2 Wireless Camera Panner, designed to apply rotation to the cable 622.

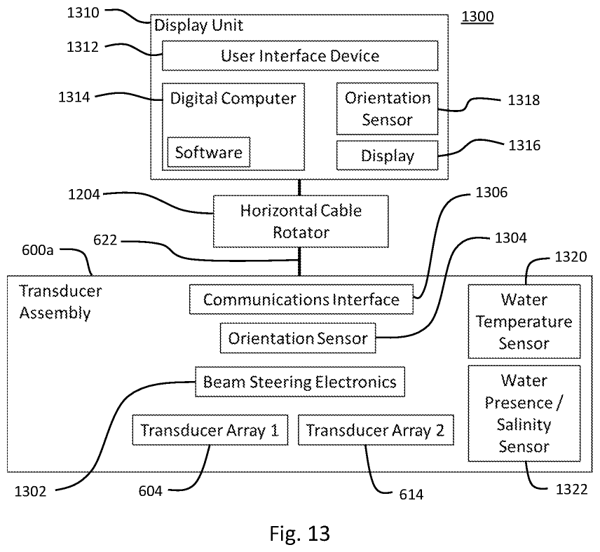

FIG. 13 is a block diagram of an exemplary system 1300 configured for three-dimensional ultrasonic mapping. A transducer assembly 600a includes two transducer arrays 604, 614, and electronics to control electronic beam steering for transmit and receive 1302. The transducer assembly also includes a transducer assembly orientation sensor 1304 that detects the three-dimensional orientation of the transducer assembly. A water temperature sensor 1320 and water salinity sensor 1322 may also be included to derive an accurate estimate of the speed of sound. The water salinity sensor 1322 works by measuring the conductivity between two electrodes separated by a known distance, and it may also be used to detect when the transducer assembly is immersed in water. Control electronics may use the presence of water to determine whether parts of the system are enabled. For example, transmit beamforming circuitry may be disabled when the transducer assembly is out of the water. Additionally, device operation that dissipates heat may be suppressed until the transducer assembly is immersed in water.

A communications interface 1306 receives data from and transmits data to a display unit 1310. A horizontal cable rotator 1204 is provided and is coupled to the transducer assembly through a cable 622. The display unit 1310 comprises a user interface device 1312, digital computer 1314 running software and a display 1316. The user interface device can include one or more of buttons, a touchscreen, a keyboard, a mouse, speakers, a microphone, a camera, and a remote control. The display unit 1310 may also incorporate a display unit orientation sensor 1318. The graphical display may be modified based on the relative orientation difference between the display unit orientation sensor 1318 and the transducer assembly orientation sensor 1304. For example, a home perspective for a three-dimensional point cloud rendering may be established that matches the perspective of a user looking at the display. In this way, looking at the display is analogous to looking through a window into the water beneath. As another example, the three-dimensional view perspective can be depicted with an icon showing the direction of the current perspective superimposed onto a top-down view. This top-down view can be oriented with forward relative to the display pointing up by using the display unit orientation sensor 1318.

The software running on the digital computer is programmed to configure the electronics in the transducer assembly and receive data for each beam from the transducer assembly. The software can also be configured to control the mechanical rotation of the transducer assembly and/or receive the current orientation of the transducer assembly as measured by the orientation sensor.

Each set of beam data received from the transducer assembly can be mapped three-dimensionally by projecting the two-dimensional image onto a plane or slice that matches the current orientation of the transducer assembly. As the transducer assembly is rotated, a three-dimensional point cloud is formed and can be rendered to the display. The intensity of each point can also be retained in the three-dimensional point cloud to provide improved capability to interpret the three-dimensional image. The user interface device can be used to orbit around the image, zoom into specific features, and select objects for the software to calculate their positions and report them on the display.

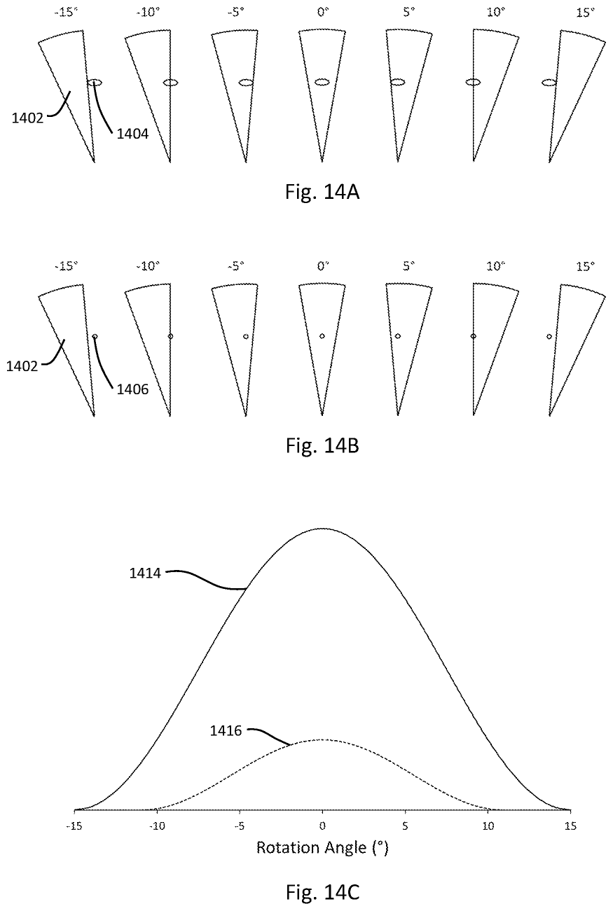

Direct transfer of each two-dimensional image to the point cloud results in objects appearing wider than they are. This is a consequence of the relatively wide beam width in the direction perpendicular to electronic steering. FIGS. 14A-14C depict detection of and expected responses from two objects 1404, 1406 of different sizes as a beam 1402 is rotated through the objects 1404, 1406. FIG. 14A and FIG. 14B depict time sequence top-down view snapshots of a beam 1402 as it rotates from −15 degrees to +15 degrees. The larger object 1404, spanning approximately 10 degrees, is shown in FIG. 14A. The smaller object 1406, spanning approximately 2 degrees, is shown in FIG. 14B. The two objects 1404, 1406 are assumed to be a same distance from the transducer assembly. The left and right boundaries of the beam 1402 demarcate the width of the beam 1402 for the purposes of simplifying the description herein. In particular, the boundaries represent an ultrasonic intensity that is 3 dB below a peak ultrasonic intensity at a center axis of the beam 1402 between the boundaries. Although sound is propagated at lower intensities beyond the designated 3 dB threshold boundaries, in much the same way that a flashlight beam does not have sharply defined edges, the following description will ignore the lower intensities in order to simplify the explanation.

When the beam 1402 is at −15 degrees, neither object 1404, 1406 is within the beam 1402. As the beam 1402 rotates to −10 degrees, the larger object 1404 overlaps the beam by approximately 5 degrees, while the smaller object 1406 overlaps the beam by approximately 1 degree. This results in expected amplitude responses at the time of first reflection as shown in FIG. 14C. Progressing through the remaining angles in sequence, the larger size of the object 1404 produces a larger amplitude response 1414 that extends over a wider range of angles. The smaller size of the object 1406 produces a smaller amplitude response 1416 that extends over a narrower range of angles. The span of angles that each object 1404, 1406 provides an echo from is larger than the span of angles where each object 1404, 1406 intersects the beam 1402. Therefore, a desirable feature of three-dimensional mapping is to properly represent the size of objects in the three-dimensional image.

Synthetic aperture processing is the name given to a category of signal processing techniques that are applied to a moving sensor or sensor array, where the response of the sensor from two or more locations at two or more corresponding times are combined to generate an image with improved resolution. The image obtained is similar to what can be achieved by having more sensors at the locations used in the analysis. In one synthetic aperture technique that uses magnitude, an expected magnitude versus angle response, similar to the small object response 1416 depicted in FIG. 14C, is used as an expectation function; and the degree of correlation is calculated for each angle. The correlation is calculated and plotted at each angle, resulting in a narrowing of response peaks. A context-aware threshold that adjusts for the intensity of objects can also be applied to provide sharp edges while preserving low amplitude targets.

In another synthetic aperture technique, magnitude and phase of each sensor response are used in the signal processing. Small changes in distance resulting from the motion of the array result in corresponding changes in phase. The phase difference between two or more subsequent rotation angles can be used to determine an angle to the object.

Image-based object recognition algorithms can also be used to improve dimensional accuracy of rendered images in the rotational direction. The image pattern associated with the expected amplitude responses shown in FIG. 14C can be detected by image recognition software, and the image replaced with an image that is appropriately compacted in the rotational direction.

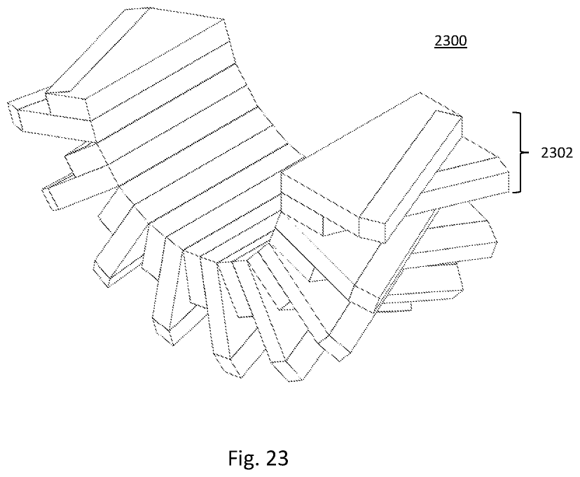

The use of mechanical rotation as described assembles a three-dimensional point cloud from multiple two-dimensional data records, or slices, collected at different times. While the two-dimensional imaging occurs near real-time, the speed of three-dimensional point cloud generation is limited by the combination of sound velocity and mechanical rotation speed. FIG. 23 depicts an array of 9 sets of 2 frequency and phase steered transducer arrays 2302 configured to provide an area of coverage of 360 degrees around a Z axis without requiring mechanical rotation. Because sound can be generated and received simultaneously from each set of two transducer arrays, this configuration allows the three-dimensional point cloud to be updated in near real-time. Furthermore, the difference in signals between adjacent sets can be used to improve the accuracy of an angle of arrival estimate. Continuous coverage is provided as long as the relative angle between each set of two transducer arrays and its adjacent sets of two transducer arrays is less than or equal to an elevation beam width of the sets.

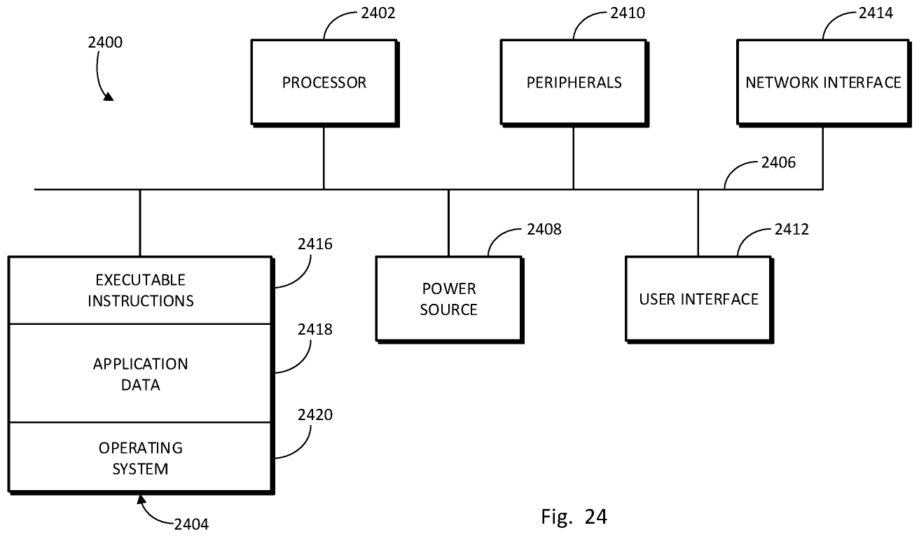

FIG. 24 is a block diagram of an example internal configuration of a computing device 2400 of an ultrasonic beamforming system. In one example configuration, the computing device 2400 may implement elements of the multibeam ultrasonic transducer assembly shown in FIG. 10. In another example configuration, the computing device 2400 may implement elements of the display unit 1310 and/or the transducer assembly 600a shown in FIG. 13.

The computing device 2400 includes components or units, such as a processor 2402, a memory 2404, a bus 2406, a power source 2408, peripherals 2410, a user interface 2412, a network interface 2414, other suitable components, or a combination thereof. One or more of the memory 2404, the power source 2408, the peripherals 2410, the user interface 2412, or the network interface 2414 can communicate with the processor 2402 via the bus 2406.

The processor 2402 is a central processing unit, such as a microprocessor, and can include single or multiple processors having single or multiple processing cores. Alternatively, the processor 2402 can include another type of device, or multiple devices, configured for manipulating or processing information. For example, the processor 2402 can include multiple processors interconnected in one or more manners, including hardwired or networked. The operations of the processor 2402 can be distributed across multiple devices or units that can be coupled directly or across a local area or other suitable type of network. The processor 2402 can include a cache, or cache memory, for local storage of operating data or instructions.

The memory 2404 includes one or more memory components, which may each be volatile memory or non-volatile memory. For example, the volatile memory can be random access memory (RAM) (e.g., a DRAM module, such as DDR DRAM). In another example, the non-volatile memory of the memory 2404 can be a disk drive, a solid state drive, flash memory, or phase-change memory. In some implementations, the memory 2404 can be distributed across multiple devices. For example, the memory 2404 can include network-based memory or memory in multiple clients or servers performing the operations of those multiple devices.

The memory 2404 can include data for immediate access by the processor 2402. For example, the memory 2404 can include executable instructions 2416, application data 2418, and an operating system 2420. The executable instructions 2416 can include one or more application programs, which can be loaded or copied, in whole or in part, from non-volatile memory to volatile memory to be executed by the processor 2402. For example, the executable instructions 2416 can include instructions for performing some or all of the techniques of this disclosure. The application data 2418 can include user data, database data (e.g., database catalogs or dictionaries), or the like. In some implementations, the application data 2418 can include functional programs, such as a web browser, a web server, a database server, another program, or a combination thereof. The operating system 2420 can be, for example, Microsoft Windows®, Mac OS X®, or Linux®, an operating system for a mobile device, such as a smartphone or tablet device; or an operating system for a non-mobile device, such as a mainframe computer.

The power source 2408 provides power to the computing device 2400. For example, the power source 2408 can be an interface to an external power distribution system. In another example, the power source 2408 can be a battery, such as where the computing device 2400 is a mobile device or is otherwise configured to operate independently of an external power distribution system. In some implementations, the computing device 2400 may include or otherwise use multiple power sources. In some such implementations, the power source 2408 can be a backup battery.

The peripherals 2410 includes one or more sensors, detectors, or other devices configured for monitoring the computing device 2400 or the environment around the computing device 2400. For example, the peripherals 2410 can include a geolocation component, such as a global positioning system location unit. In another example, the peripherals can include a temperature sensor for measuring temperatures of components of the computing device 2400, such as the processor 2402. In some implementations, the computing device 2400 can omit the peripherals 2410.

The user interface 2412 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, virtual reality display, or other suitable display.

The network interface 2414 can provide a connection or link to a network. The network interface 2414 can be a wired network interface or a wireless network interface. The computing device 2400 can communicate with other devices via the network interface 2414 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are examples of what is specifically intended and all possible combinations of numerical values between the lowest value and the highest value enumerated are to be considered to be expressly stated in this application in a similar manner.

Unless otherwise stated, all ranges include endpoints and all numbers between the endpoints. The use of “about” or “approximately” in connection with a range applies to ends of the range. Thus, “about 20 to 30” is intended to cover “about 20 to about 30”, inclusive of at least the specified endpoints.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law

What is claimed is:

1. A system, comprising:
transmit beamforming electronics configured to control a transducer assembly to transmit a plurality of beams around an electronic beam steering axis by varying a frequency and a phase between channels connected to transducer elements of the transducer assembly, wherein the channels are greater in number than two and less in number than the transducer elements, and a phase difference between adjacent channels is an integer multiple of 360 degrees divided by the number of channels;
receive beamforming electronics configured to detect, via the transducer assembly, a plurality of echoes caused by the plurality of beams;
a rotator configured to rotate the transducer assembly around a rotation axis that is perpendicular to the electronic beam steering axis while transmitting the plurality of beams and detecting the plurality of echoes; and
a processor configured to execute instructions stored in a memory to generate a three-dimensional ultrasonic mapping based on the plurality of echoes and output the three-dimensional ultrasonic mapping to a display unit.

2. The system of claim 1, wherein the transducer assembly includes two or more transducer arrays including the transducer elements, the two or more transducer arrays configured to cooperatively provide coverage over a range of angles of at least 160 degrees around the electronic beam steering axis.

3. The system of claim 1, further comprising:
a transducer assembly orientation sensor configured to measure a three-dimensional orientation of the transducer assembly; and
a display unit orientation sensor configured to measure a three-dimensional orientation of the display unit, wherein the three-dimensional ultrasonic mapping changes at the display unit based on the three-dimensional orientation of the transducer assembly and the three-dimensional orientation of the display unit.

4. The system of claim 1, wherein at least two beams of the plurality of beams share a frequency and differ in phase.

5. The system of claim 1, wherein the transducer assembly includes a water temperature sensor used to estimate a speed of sound in water.

6. The system of claim 1, wherein the transducer assembly includes a salinity sensor used to estimate a speed of sound in water.

7. The system of claim 1, wherein the rotator is a mechanical rotation device that includes a horizontal cable rotator that rotates the transducer assembly by rotating a cable attached to the transducer assembly.

8. The system of claim 1, wherein the transducer assembly includes two transducer arrays, each transducer array of the two transducer arrays includes 8 channels, and a phase difference between adjacent channels of the 8 channels for each beam of the plurality of beams is at least one of 45 degrees, 90 degrees, 135 degrees, −45 degrees, −90 degrees, or −135 degrees.

9. The system of claim 1, wherein the transducer assembly includes two transducer arrays, each transducer array is a linear array, the two transducer arrays are angled symmetrically to a positive and negative angle with respect to a vertical reference angle, respectively, and each of the positive and negative angles is in a range from 15 degrees to 25 degrees.

10. The system of claim 1, wherein the receive beamforming electronics include:
analog to digital converters, each providing a received digitized signal for each channel;
digital demodulators, each comprising two or more mixers and two or more low-pass filters for a channel and frequency;
phase rotators; and
beamforming summation blocks, wherein:
a first mixer of the two or more mixers for a channel and frequency multiplies a received digitized signal with a cosine waveform and a resulting product is fed into a first low-pass filter of the two or more low-pass filters to generate an in-phase (I) signal for the channel and frequency, and a second mixer of the two or more mixers for the channel and frequency multiplies the received digitized signal with a sine waveform and the resulting product is fed into a second low-pass filter of the two or more low-pass filters to generate a quadrature (Q) signal for the channel and frequency;
the phase rotators are configured to rotate demodulated I and Q signals for each channel and frequency by one or more phase angles matching one or more phase angles used to generate a beam of the plurality of beams for the channel and frequency; and
the beamforming summation blocks are configured to perform receive beamforming by summing the rotated I and Q signals from each channel and frequency to steer the received signal in a same direction the beam of the plurality of beams was steered.

11. The system of claim 1, further comprising:
a gradient acoustic matching structure configured to contact a transducer array of the transducer assembly on a first side and water outside of the transducer assembly on a second side, the gradient acoustic matching structure having a higher acoustic impedance on the first side and a lower acoustic impedance on the second side.

12. The system of claim 1, further comprising:
a gradient acoustic matching structure configured to contact a transducer array of the transducer assembly on a first side and water outside of the transducer assembly on a second side, the gradient acoustic matching structure including layers of wire mesh that vary in at least one of mesh size, wire diameter, or wire material.

13. A method, comprising:
controlling a transducer assembly to transmit a plurality of beams around an electronic beam steering axis by varying a frequency and a phase between channels connected to transducer elements of the transducer assembly, wherein the channels are greater in number than two and less in number than the transducer elements, and a phase difference between adjacent channels is an integer multiple of 360 degrees divided by the number of channels;
detecting, via the transducer assembly, a plurality of echoes caused by the plurality of beams;
rotating the transducer assembly around a rotation axis that is perpendicular to the electronic beam steering axis while transmitting the plurality of beams and detecting the plurality of echoes; and
generating a three-dimensional ultrasonic mapping based on the plurality of echoes, the three-dimensional ultrasonic mapping being output to a display unit.

14. The method of claim 13, wherein controlling the transducer assembly includes:
providing, cooperatively among two or more transducer arrays of the transducer assembly, coverage over a range of angles of at least 160 degrees around the electronic beam steering axis.

15. The method of claim 13, further comprising:
determining a speed of sound in water; and
changing a reference clock, used when varying the frequency and the phase, based on the speed of sound that is determined.

16. The method of claim 13, further comprising:
measuring a three-dimensional orientation of the transducer assembly;
measuring a three-dimensional orientation of the display unit;
outputting the three-dimensional ultrasonic mapping to the display unit; and changing the three-dimensional ultrasonic mapping based on the three-dimensional orientation of the transducer assembly and the three-dimensional orientation of the display unit.

17. The method of claim 13, further comprising:
demodulating a received signal for each channel at frequencies used to transmit the plurality of beams, wherein the demodulating preserves phase information for each channel at each frequency.

18. A system, comprising:
a transducer assembly including multiple sets of two frequency and phase steered transducer arrays, each set of two frequency and phase steered transducer arrays angled relative to adjacent sets of two frequency and phase steered transducer arrays;
transmit beamforming electronics configured to control the transducer assembly to transmit a plurality of beams around an electronic beam steering axis by varying a frequency and a phase between channels connected to transducer elements of the transducer array;
receive beamforming electronics configured to detect, via the transducer assembly, a plurality of echoes caused by the plurality of beams; and
a processor configured to execute instructions stored in a memory to generate a three-dimensional ultrasonic mapping based on the plurality of echoes and output the three-dimensional ultrasonic mapping to a display unit.

19. The system of claim 18, wherein each set of two frequency and phase steered transducer arrays is configured to cooperatively provide coverage over a range of angles of at least 160 degrees around the electronic beam steering axis.

20. The system of claim 18, wherein for each set of two frequency and phase steered transducer arrays the channels are greater in number than two and less in number than the transducer elements and a phase difference between adjacent channels is an integer multiple of 360 degrees divided by the number of channels.
